(19) United States
(12) Patent Application Publication
(10) Pub. No.: US 2026/0099749 A1
(43) Pub. Date: Apr. 9, 2026

(54) QUANTUM ENTANGLEMENT MANAGEMENT FOR QUANTUM INFORMATICS

(71) Applicant: PHOTONIC INC., Coquitlam (CA)

(72) Inventors: Stephanie SIMMONS, Burnaby (CA); Camille CHARTRAND, Burnaby (CA)

(21) Appl. No.: 19/112,739

(22) PCT Filed: Sep. 19, 2023
(86) PCT No.: PCT/CA2023/051241

§ 371 Date: Mar. 18, 2025

Related U.S. Application Data
(60) Provisional application No. 63/377,342, filed on Sep. 27, 2022.
(60) Provisional application No. 63/501,598, filed on May 11, 2023.

(51) Int. Cl. G06N 10/40; G06N 10/20

(52) U.S. Cl. CPC G06N 10/40; G06N 10/20

(57) ABSTRACT

A control system for a network of quantum systems operates the network to perform quantum informatics processing. The control system includes an entanglement scheduler configured to identify operations for which entanglement of two or more of the quantum systems is desired, identify plural potential entanglement attempts for generating the entanglement; and schedule at least some of the potential entanglement attempts to be performed to generate the entanglement for at least one of the operations. The entanglement scheduler may use direct entanglement, entanglement swapping and/or quantum teleportation approaches to generate the entanglement. The entanglement scheduler may schedule probabilistic entanglement attempts based at least in part on the probability of success of the entanglement attempts. The entanglement scheduler may generate entanglement to support plural branches of a quantum informatics process and/or to respond to events occurring while the quantum informatics process is executing.

### CROSS-REFERENCE TO RELATED APPLICATION

This application claims priority from U.S. application No. 63/377,342 filed 27 Sep. 2022 and entitled QUANTUM ENTANGLEMENT MANAGEMENT FOR QUANTUM INFORMATICS and U.S. application No. 63/501,598 filed 11 May 2023 and entitled QUANTUM ENTANGLEMENT MANAGEMENT FOR QUANTUM INFORMATICS which are hereby incorporated herein by reference for all purposes. For purposes of the United States of America, this application claims the benefit under 35 U.S.C. § 119 of U.S. application No. 63/377,342 filed 27 Sep. 2022 and entitled QUANTUM ENTANGLEMENT MANAGEMENT FOR QUANTUM INFORMATICS and U.S. application No. 63/501,598 filed 11 May 2023 and entitled QUANTUM ENTANGLEMENT MANAGEMENT FOR QUANTUM INFORMATICS which are hereby incorporated herein by reference for all purposes.

### FIELD

This technology relates to quantum information management. Aspects of the technology relate to optical quantum networks which include matter-based quantum systems and associated methods.

### BACKGROUND

Quantum informatics involves storing and/or manipulating information represented by the state of a quantum system or a set of quantum systems. Quantum informatics includes quantum computing.

Quantum information may, for example, be represented by the states of quantum systems as diverse as photons, Josephson junctions (superconducting qubits), electron spins and nuclear spins in solid state defects, trapped ions and others.

Quantum informatics is a rapidly developing field. There is a strong demand for quantum networks capable of managing and manipulating large amounts of quantum information. While one can readily scale up the number of quantum systems (e.g. qubits) in a quantum information processing network it is a significant technical problem to provide interconnectivity that will provide desired interactions between the quantum systems, for example to transfer quantum information within the network, perform quantum gates on pairs or groups of quantum systems within the network, create quantum entanglement of quantum systems, etc.

One type of quantum network is an optical quantum network which uses photons to carry quantum information among different matter-based quantum systems. Photons may be carried on optical links. Optical switches may be provided to guide photons along selected paths. As the size of an optical quantum network is scaled to include more quantum systems the size and complexity of the system of optical links that provides interconnectivity between the quantum systems also increases.

There is a need for practical systems operable to perform quantum computing and other quantum informatics processing.

### SUMMARY

This invention has a number of aspects, these include without limitation:
systems and methods for managing entanglement of quantum systems as a resource to support quantum operations;
systems and methods for scheduling attempts to entangle quantum systems to yield entanglement to support quantum operations;
networks or quantum systems useful for quantum computing and/or other quantum informatics applications;
methods for mapping virtual qubits (or other qudits) to physical quantum systems;
architectures for implementing quantum processing on networks of quantum systems; and
methods and systems for controlling networks of quantum systems to perform quantum informatics processes.

One example aspect of the invention provides a control system for a network of quantum systems. The control system is operable to operate the network of quantum systems to perform quantum informatics processing. The control system comprises an entanglement scheduler that is configured to, for a plurality of operations to be performed on the quantum systems of the network: identify one or more of the operations that require entanglement of quantum states of two or more of the quantum systems; identify plural potential entanglement attempts for generating the required entanglement; and schedule at least some of the potential entanglement attempts to be performed to generate the required entanglement for at least one of the operations prior to execution of the at least one of the operations.

In some embodiments the control system is configured to process the program that specifies the operations to be performed on the quantum systems of the network to identify probabilistic operations.

In some embodiments, for at least one of the one or more operations, identifying the potential entanglement attempts is based at least in part on a characterization of the required entanglement for the at least one of the one or more operations.

In some embodiments the entanglement scheduler is configured to perform characterizing the required entanglement corresponding to each of the one or more operations. In some embodiments characterizing the required entanglement comprises identifying quantum systems of the network to be entangled to generate the required entanglement. In some embodiments characterizing the required entanglement comprises determining a level of fidelity for the required entanglement. In some embodiments characterizing the required entanglement comprises determining a level of criticality of the one or more operations. In some embodiments characterizing the required entanglement comprises determining a fidelity for the required entanglement.

In some embodiments scheduling at least some of the potential entanglement attempts comprises identifying a hardware conflict that blocks simultaneous execution of two or more of the potential entanglement attempts and scheduling the two or more of the potential entanglement attempts to be performed at different times in response to the identification of the hardware conflict.

In some embodiments the network comprises a plurality of optical switches and the control system is configured to control states of the optical switches to configure the network for executing the at least some of the scheduled potential entanglement attempts. In some embodiments the control system is configured to maintain a network configuration data structure containing information regarding the state and availability of hardware components of the network for use in executing entanglement attempts. In some embodiments the entanglement scheduler is configured to identify those of the potential entanglement attempts that can be executed with the network in a current configuration based on the information in the network configuration data structure. In some embodiments the network configuration data structure includes information regarding the states of the optical switches of the network and information regarding the states of Bell state analyzers of the network. In some embodiments the network configuration data structure includes quantum system utilization information regarding which of the quantum systems of the network are available for use in entanglement attempts.

In some embodiments identifying the plurality of potential entanglement attempts comprises identifying at least one entanglement swapping chain that includes as endpoints a first one of the quantum systems and a second one of the quantum systems wherein the potential entanglement attempts include potential entanglement attempts to entangle each of plural portions of a path corresponding to the entanglement swapping chain. In some embodiments identifying at least one entanglement swapping chain comprises identifying two or more entanglement swapping chains that each have as endpoints the first one of the quantum systems and the second one of the quantum systems. In some embodiments the entanglement scheduler is configured to perform identifying at least one entanglement swapping chain by steps that comprise processing an entanglement graph for the network of quantum systems, the entanglement graph comprising vertices and edges, to find one or more sets of the edges, wherein each of the sets of edges forms a path extending between the first and second ones of the quantum systems. In some embodiments one or more parameters are associated with edges of the entanglement graph and scheduling at least some of the potential entanglement attempts to be performed to generate the required entanglement is based at least in part on values of the one or more parameters corresponding to the one or more of the edges.

In some embodiments the parameters comprise lossiness parameters that indicate a degree of lossiness of one or more optical paths corresponding to the edges.

In some embodiments identifying the at least one entanglement swapping chain comprises using identifiers for the first and second ones of the quantum system as keys to retrieve from a data structure the at least one entanglement swapping chain.

In some embodiments the control system comprises a data store comprising a data structure that defines the entanglement graph. The entanglement graph that reflects a topology of the network. In some embodiments the entanglement graph is not all-to-all connected. In some embodiments the entanglement graph is non-planar. In some embodiments the entanglement graph is a regular graph or the regular graph with one or more vertices deleted. In some embodiments the regular graph is a distance regular graph. In some embodiments one or more parameters are associated with edges of the entanglement graph and scheduling at least some of the potential entanglement attempts to be performed to generate the required entanglement is based at least in part on values of the one or more parameters corresponding to the one or more of the edges.

In some embodiments prioritizing the potential entanglement attempts comprises assigning a weight to each of the potential entanglement attempts and scheduling the proposed entanglement attempts in an order that is based on the corresponding weights. In some embodiments wherein the weight is based at least in part on one or more of the following factors:
an estimated length of time before execution of one of the operations associated with the entanglement attempt according to the schedule;
a number of other operations to be executed before execution of one of the operations associated with the entanglement attempt;
a probability of success of the entanglement attempt an expected fidelity of entanglement that will be generated if the entanglement attempt succeeds;
a time required to configure hardware of the network to perform the entanglement attempt;
a time required to execute the entanglement attempt;
a measure of how much a configuration of the hardware of the network to perform the entanglement attempt conflicts with performing other ones of the potential entanglement attempts;
a criticality of one of the operations associated with the potential entanglement attempt; and
a priority of an entanglement chain associated with the potential entanglement attempt.

In some embodiments the weights for the potential entanglement attempts are based on combinations of two or more of the above factors.

In some embodiments the control system is configured to execute the operations in a sequence of execution stages and to perform selected ones of the potential entanglement attempts in plural entanglement generation stages in periods between successive ones of the execution stages. In some embodiments the potential entanglement attempts are probabilistic entanglement attempts and the entanglement scheduler is configured to schedule the potential entanglement attempts associated with one of the operations sufficiently in advance of one of the execution stages in which the operation is scheduled to allow the potential entanglement attempts to be repeated enough times prior to the one of the execution stages that a likelihood of success of the one of the execution stages prior to the one of the execution stages is at least a threshold probability. In some embodiments the entanglement scheduler is configured to set the threshold probability based on a criticality of the one of the operations with which the proposed entanglement attempt is associated. In some embodiments the entanglement scheduler is configured to, after each of the entanglement generation stages determine results of the entanglement attempts performed in the entanglement generation stage and, based on the determined results update the potential entanglement attempts. In some embodiments the control system is configured to assign updated weights to the updated entanglement attempts. In some embodiments the control system is configured to schedule the updated entanglement attempts in a sequence according to the updated weights.

In some embodiments the entanglement scheduler is configured to map abstract qubits specified in the program to corresponding ones of the quantum systems of the network. In some embodiments the entanglement scheduler is configured to dynamically remap the abstract qubits specified by the program to the corresponding ones of the quantum systems while the program is running. In some embodiments the entanglement scheduler is configured to determine whether or not to remap one or more of the abstract qubits based on a comparison of an expected cost of creating entanglement to remap the one or more of the abstract qubits to an expected saving of cost of creating entanglement as a result of remapping the one or more abstract qubits. In some embodiments the entanglement scheduler is configured to perform the mapping of abstract qubits specified in the program to corresponding ones of the quantum systems of the network by identifying pairs of the abstract qubits that the program requires to be entangled or to be operated on by an operation that consumes entanglement and performing an optimization directed to identify a mapping of the pairs of abstract qubits to corresponding pairs of the quantum systems. In some embodiments the mapping is based on minimizing a time to provide the required entanglement. In some embodiments the mapping is based on a degree of lossiness of optical paths that may be used to entangle the quantum states of the pairs of the quantum systems. In some embodiments the mapping attempts to increase a number of the corresponding pairs of the quantum systems for which the entanglement of the pair of quantum systems can be generated by direct entanglement. In some embodiments mapping the abstract qubits specified in the program to corresponding ones of the quantum systems of the network is based at least in part on a fidelity for the required entanglement. In some embodiments mapping the abstract qubits specified in the program to corresponding ones of the quantum systems of the network is based at least in part on an estimated time required to create the required entanglement. In some embodiments mapping the abstract qubits specified in the program to corresponding ones of the quantum systems of the network is based at least in part on one or a combination of the following factors:
a length of time before scheduled execution of one of the operations associated with the entanglement attempt;
a number of other operations to be executed before execution of one of the operations associated with the entanglement attempt;
a probability of success of the potential entanglement attempt;
an expected fidelity of entanglement that will be generated if the entanglement attempt succeeds;
a time required to configure hardware of the network to perform the entanglement attempt;
a measure of how much a configuration of the hardware of the network to perform the entanglement attempt conflicts with performing other ones of the potential entanglement attempts;
a criticality of one of the operations associated with the potential entanglement attempt; and
a priority of an entanglement chain associated with the potential entanglement attempt.

In some embodiments the entanglement scheduler is configured to monitor execution of the potential entanglement attempts to identify whether or not each of the potential entanglement attempts that was executed was successful at creating entanglement. In some embodiments the entanglement scheduler is configured to, in response to determining that the required entanglement corresponding to one of the one or more operations has not been achieved by a deadline at or before a scheduled time of execution of the one of the one or more operations, perform one or more of:
modify the program by scheduling one or more remedial operations; and
delay execution of the one of the one or more operations; and
pause execution of operations of the program until the required entanglement corresponding to the one of the one or more operations has been achieved.

In some embodiments the entanglement scheduler is further configured to, in response to determining that the required entanglement corresponding to one of the one or more operations has been achieved bring forward scheduled execution of the one or more operations. In some embodiments the control system is configured to monitor which ones of the one or more operations are free to be executed upon generation of the required entanglement associated with the operation and to execute any ones of the operations that are free to be executed in response to determining that the required entanglement associated with such ones of the operations has been generated.

In some embodiments the control system is configured to maintain a record of entanglement of the quantum systems of the network.

In some embodiments the control system is configured to track ageing (e.g., time since entangled state was generated) and/or estimated decoherence of entanglement of individual groups of two or more entangled quantum systems of the network.

In some embodiments the control system is configured to maintain an inventory of entangled pairs of the quantum systems of the network and to create potential entanglement requests to add entanglement to the inventory when the inventory is below a desired level.

In some embodiments the network comprises a plurality of nodes, each of the plurality of nodes includes a plurality of the quantum systems for which the network includes optical connectivity configurable to facilitate entanglement with quantum systems of other ones of the nodes and the control system is configured to include in the inventory a plurality of entangled pairs of the quantum systems, each of the entangled pairs of quantum systems including one quantum system in one of the nodes and another quantum system in another one of the nodes.

In some embodiments the entanglement scheduler is configured to, in response to determining that the fidelity exceeds a threshold, include in the potential entanglement attempts a plurality of potential entanglement attempts between a plurality of different pairs of the quantum systems, execute the plurality of potential entanglement attempts between the plurality of different pairs of the quantum systems to achieve entanglement of the plurality of different pairs of the quantum systems and perform entanglement distillation on the plurality of different pairs of the quantum systems to yield the required entanglement.

In some embodiments the entanglement scheduler is configured to, in response to determining that the fidelity exceeds a threshold, include in the potential entanglement attempts a plurality of potential entanglement attempts between one or more pairs of the quantum systems, execute the plurality of potential entanglement attempts between the one or more pairs of the quantum systems to achieve entanglement of the one or more pairs of the quantum systems and perform entanglement distillation involving the one or more pairs of the quantum systems to yield the required entanglement. In some embodiments the quantum systems of the network include at least two luminescent centres that each include an electron spin and a nuclear spin wherein the control system is configured to:
a, entangle the electron spins two of the luminescent centres;
b, transfer the entanglement to the nuclear spins of the two of the luminescent centres;
c, entangle the electron spins of the two of the luminescent centers again; and
d, perform entanglement distillation between the entangled electron spins and the nuclear spins.

In some embodiments the control system is combined with the network of quantum systems and the control system is connected to apply the operations to the quantum systems of the network and to execute the scheduled entanglement attempts on the quantum systems of the network. In some embodiments the quantum systems of the network comprise matter based quantum systems that are supported in or on a substrate. In some embodiments the quantum systems are provided by luminescent centers in the substrate. In some embodiments the substrate is silicon and the luminescent centers comprise T centers.

In some embodiments control system network combination comprises a plurality of Bell state analyzers, the Bell state analyzers each having first and second input ports and optical links that are configured or configurable to provide optical couplings that optically couple pairs of the quantum systems to the Bell state analyzer such that first and second quantum systems of each of the pairs are respectively optically coupled to the first and second input ports of a corresponding one of the Bell state analyzers.

Another aspect of the invention provides a method for operating a network of quantum systems to perform quantum informatics processing. The method comprises obtaining information that identifies one or more operations that require entanglement of quantum states of two or more of the quantum systems and characterize the required entanglement corresponding to each of one or more operations. Obtaining the information may comprise processing a program that specifies operations to be performed on the quantum systems of the network. Based on the characterization of the required entanglement for the one or more operations, the method identifies plural potential entanglement attempts for generating the required entanglement; and schedules one or more of the potential entanglement attempts to be performed to generate the required entanglement for at least one of the operations prior to execution of the at least one of the operations.

In some embodiments identifying the plural potential entanglement attempts comprises processing an entanglement graph for the network of quantum systems, the entanglement graph comprising vertices and edges to find one or more of the edges and/or one or more sets of two or more of the edges that form a path extending between the two of the quantum systems.

In some embodiments identifying the plural potential entanglement attempts comprises identifying at least one entanglement swapping chain wherein the potential entanglement attempts include potential entanglement attempts to entangle each of plural portions of a path corresponding to the entanglement swapping chain.

In some embodiments identifying at least one entanglement swapping chain comprises identifying two or more entanglement swapping chains extending between two of the quantum systems.

In some embodiments identifying at least one entanglement swapping chain comprises processing an entanglement graph for the network of quantum systems, the entanglement graph comprising vertices and edges to find one or more sets of the edges that form a path extending between the two of the quantum systems.

In some embodiments identifying at least one entanglement swapping chain comprises using identifiers for the two of the quantum system as keys to retrieve from a data structure the at least one entanglement swapping chain.

In some embodiments prioritizing the potential entanglement attempts comprises assigning a weight to each of the potential entanglement attempts and scheduling the proposed entanglement attempts in order of the corresponding weights.

In some embodiments the weight is based at least in part on one or more of:
a length of time before scheduled execution of one of the operations associated with the potential entanglement attempt;
a number of other operations to be executed before execution of one of the operations associated with the potential entanglement attempt;
a criticality of one of the operations associated with the potential entanglement attempt; and
a priority of an entanglement chain associated with the potential entanglement attempt.

In some embodiments the weights for the potential entanglement attempts are based on combinations of two or more factors.

In some embodiments the method comprises executing the operations in a sequence of execution stages and performing selected ones of the potential entanglement attempts in plural entanglement generation stages in periods between successive ones of the execution stages.

In some embodiments the method comprises executing the operations in a sequence of execution stages and performing selected ones of the potential entanglement attempts in plural entanglement generation stages in periods between successive ones of the execution stages.

In some embodiments the method comprises the potential entanglement attempts are probabilistic entanglement attempts and the method comprises scheduling the potential entanglement attempts associated with one of the operations sufficiently in advance of one of the execution stages in which the operation is scheduled to allow the potential entanglement attempts to be repeated enough times prior to the one of the execution stages that a likelihood of success of the one of the execution stages prior to the one of the execution stages is at least a threshold probability.

In some embodiments the method comprises setting the threshold probability based on a criticality of the one of the operations with which the proposed entanglement attempt is associated.

In some embodiments the method comprises, after each of the entanglement generation stages, determining results of the entanglement attempts performed in the entanglement generation stage and, based on the determined results updating the potential entanglement attempts and assigning priorities to the updated entanglement attempts.

In some embodiments the method comprises mapping abstract qubits specified in the program to corresponding ones of the quantum systems of the network.

In some embodiments the method comprises remapping the abstract qubits specified by the program to the corresponding ones of the quantum systems while the program is running.

In some embodiments the method comprises performing the mapping abstract qubits specified in the program to corresponding ones of the quantum systems of the network by identifying pairs of the abstract qubits that the program requires to be entangled and performing an optimization directed to identify a mapping of the pairs of abstract qubits to corresponding pairs of the quantum systems which maximizes a number of the corresponding pairs of the quantum systems that can be directly entangled.

In some embodiments mapping the abstract qubits specified in the program to corresponding ones of the quantum systems of the network is based at least in part on a fidelity for the required entanglement.

In some embodiments mapping the abstract qubits specified in the program to corresponding ones of the quantum systems of the network is based at least in part on reducing a number of entangled pairs of quantum systems required to execute the program.

In some embodiments monitoring execution of the potential entanglement attempts and, in response to determining that the required entanglement corresponding to one of the one or more operations has not been achieved by a deadline at or before a time of execution of the one of the one or more operations, performing one or more of:
modify the program by scheduling one or more remedial operations; and
delay execution of the one of the one or more operations; and
pause execution of the program until the required entanglement corresponding to the one of the one or more operations has been achieved.

In some embodiments characterizing the required entanglement comprises determining a fidelity for the required entanglement.

In some embodiments the method comprises, in response to determining that the fidelity exceeds a threshold, including in the potential entanglement attempts a plurality of potential entanglement attempts between a plurality of different pairs of the quantum systems, executing the plurality of potential entanglement attempts between the plurality of different pairs of the quantum systems to achieve entanglement of the plurality of different pairs of the quantum systems and performing entanglement distillation on the plurality of different pairs of the quantum systems to yield the required entanglement.

In some embodiments the method comprises tracking entanglement of the quantum systems of the network.

In some embodiments the method comprises estimating decoherence of entanglement of individual groups of two or more entangled quantum systems of the network.

In some embodiments the method comprises maintaining an inventory of entangled pairs of the quantum systems of the network at a desired level and to create potential entanglement requests to add entanglement to the inventory when the inventory is below the desired level.

In some embodiments the network comprises a plurality of nodes, each of the plurality of nodes includes a plurality of the quantum systems that are exposed to facilitate entanglement with others of the quantum systems that are exposed by other ones of the nodes and the control system is configured to include in the inventory a specified level of entangled pairs of the quantum systems that are exposed by first and second different ones of the nodes.

In some embodiments the method accesses a data store comprises a data structure that defines an entanglement graph that reflects a topology of the network. In some embodiments the entanglement graph is not all-to-all connected.

In some embodiments the entanglement graph is a regular graph or the regular graph with one or more vertices deleted.

In some embodiments the regular graph is a distance regular graph.

In some embodiments the method comprises applying the operations to the quantum systems of the network and executing the entanglement attempts on the quantum systems of the network.

In some embodiments the quantum systems of the network comprise matter based quantum systems that are supported in or on a substrate.

In some embodiments the quantum systems are provided by luminescent centers in the substrate.

In some embodiments the network comprises a plurality of Bell state analyzers, the Bell state analyzers each having first and second input ports and optical links that are configured or configurable to provide optical couplings that optically couple pairs of the quantum systems to the Bell state analyzer such that first and second quantum systems of each of the pairs are respectively optically coupled to the first and second input ports of a corresponding one of the Bell state analyzers.

In some embodiments the substrate is silicon and the luminescent centers comprise T centers.

Another aspect of the invention provides an optical quantum network comprising a plurality of nodes. Each of the nodes comprises at least one quantum system. At least one of the at least one quantum system of each of the nodes has an optical transition. Each of the nodes is optically coupled to one or more Bell state analyzers by optical links to provide connectivity that corresponds to a connected entanglement graph made up of vertices and edges that each connect two of the vertices. The entanglement graph includes some pairs of vertices that are not connected to one another by an edge and other pairs of vertices that are connected to one another by an edge. The vertices of the graph correspond to the nodes;
the edges of the graph correspond to connectivity of each of the nodes corresponding to the vertices joined by the edge to at least one of the one or more Bell state analyzers. The optical links are configured so that where an edge of the graph joins vertices that correspond to two of the nodes, the optical links provide connectivity of each of the two of the nodes to a respective input port of the same Bell state analyzer such that the Bell state analyzer can perform a Bell state measurement on photons received from the pair of nodes. Where two vertices are not joined by an edge the optical links do not provide connectivity of the nodes corresponding to the two vertices to the same Bell state analyzer. The network includes an entanglement scheduler configured to process a program to identify future operations that require entanglement of quantum systems associated with the nodes and to schedule entanglement attempts to create the required entanglement in time to support the future operations.

In some embodiments the entanglement scheduler is further configured to create and maintain an inventory of entangled states.

In some embodiments the control system is operable to operate the network of quantum systems to perform quantum informatics processing. The control system operable to: receive a sequence of operations to be performed on the quantum systems of the network wherein at least some of the operations require existence of entanglement of quantum states of two or more of the quantum systems of the network; control the network to generate the required entanglement by a probabilistic entanglement protocol; and control the network to perform each of the operations upon completion of any other operations that are preconditions for execution of the operation and generation of any entanglement required for the operation.

Another aspect of the invention provides apparatus having any new and inventive feature, combination of features, or sub-combination of features as described herein.

Another aspect of the invention provides methods having any new and inventive steps, acts, combination of steps and/or acts or sub-combination of steps and/or acts as described herein.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a conceptual illustration showing an example quantum network according to an embodiment.

FIG. 2 illustrates an example schedule that includes entanglement generation stages in which entanglement attempts are performed and execution stages in which operations are performed.

FIG. 3 is a schematic illustration showing example data sources that may be provided to inform operation of an entanglement scheduler.

FIG. 4A is a simple example entanglement graph.

FIG. 4B is one example of hardware comprising optical connections that implement the connectivity of the entanglement graph of FIG. 4A.

FIGS. 5A to 5F are examples of entanglement paths or “chains” that may be applied to create entanglement of quantum systems associated with different vertices of an entanglement graph.

FIG. 6A is a graphical depiction of a portion of an example quantum circuit.

FIG. 6B is a sketch showing a timeline indicating periods when entanglement attempts may be made to provide entanglement to implement the quantum circuit of FIG. 6A.

FIG. 7 is a schematic illustration showing features of an example hardware implementation of a quantum network.

FIG. 8 is a flow chart for an example entanglement scheduling method.

FIGS. 9A to 9I show example status of an example network at various timesteps during the execution of an example quantum circuit.

FIG. 10 shows a summary of the timesteps and instruction cycles of an example quantum circuit.

FIGS. 11A to 11I are schematically illustrations that show stages in an example strategy for providing entanglement between quantum systems in different nodes of a quantum network.

### DEFINITIONS

“Optically connected” in the context of quantum systems means “connected” by an optical path, optical link, optical waveguide or optical network extending between the quantum systems. “Optically connected” includes the case where the optical path, optical link, optical waveguide or optical network is operable to carry photons or photon states emitted by each of the quantum systems to a location (e.g. an optical mixer, optical beamsplitter, optically coupled waveguides etc.) where the photons or photon states can interact (e.g. interfere) with one another. For example, two quantum systems are “connected” when an optical network is configured to deliver photons originating from each of the optical systems to an interaction unit having first and second inputs respectively arranged to receive photon states originating from the connected quantum systems and first and second outputs respectively arranged to deliver photons to first and second single photon detectors where the interaction units are configured to allow interference between the photon states originating from the connected quantum systems.

“Entanglement” or “entangled state” describes the situation in which quantum states of individual quantum systems in a group of two or more quantum systems cannot be described independently of the quantum states of the other ones of the quantum systems in the group. An equivalent definition of an entangled state is a state of plural quantum systems that cannot be factored into states of the individual quantum systems that make it up. For example, two entangled particles may each have a quantum state which is a superposition of spin up and spin down while the combined spin of the two particles is constrained to be zero. Entanglement can exist even between quantum systems that are separated by very large distances. An example of an entangled state of two particles is a Bell state. Two or more quantum systems are said to be “entangled” when their quantum states are entangled.

“Entanglement attempt” means an attempt to create entanglement of two quantum systems using an entanglement protocol. Some entanglement protocols are probabilistic (i.e. an entanglement attempt using a probabilistic protocol has a likelihood, p of being successful where p<1). Where a probabilistic protocol is used to create entanglement between two quantum systems, on average, more than one entanglement attempt is required to achieve entanglement. The average number of entanglement attempts to create entanglement becomes larger as p becomes smaller. An entanglement protocol may be probabilistic where the design of the protocol is such that there are outcomes in which entanglement is not achieved and/or where photons or other particles used in the entanglement protocol have a probability of being lost, thereby causing the protocol to fail to create entanglement. For example, certain entanglement protocols that include making Bell state measurements have, a probability of successfully generating entanglement that is less than one, photon loss can further reduce the probability of success when such an entanglement protocol is executed. Consequently, more than one entanglement attempt may need to be executed to generate desired entanglement. An entanglement scheduler may schedule a plurality of potential entanglement attempts for generating a desired entanglement. If one of the potential entanglement attempts is executed and succeeds at generating the desired entanglement then it may be unnecessary to execute any of the potential entanglement attempts that are subsequent to the successful entanglement attempt.

“Consumption” when referencing entanglement or an entangled state means that the entanglement or entangled state is used to advance execution of a program in a way that makes the entanglement or entangled state no longer available for other operations. For example, entanglement that is used to implement a remote (teleported) gate is consumed by measurements that are applied to implement the remote gate and is subsequently no longer available.

“Highly entangled state” means a state that is maximally entangled or close to being maximally entangled. A Bell pair is an example of a highly entangled state.

Two quantum systems can be “directly entangled” when they are coupled in such a manner that an entanglement protocol may be executed to entangle the two quantum systems without entanglement swapping. For example two quantum systems may be directly entangled if their wavefunctions overlap sufficiently. As another example, two quantum systems may be directly entangled if they are coupled by hyperfine coupling or spin-orbit coupling. As another example, two quantum systems may be directly entangled if they are each optically coupled to a respective input port of a Bell state analyzer. As another example, two quantum systems may be directly entangled where the quantum systems are optically connected by way of an optical path that is coupled to a photon source and a photon detector such that a photon from the photon source can interact with both quantum systems and then be measured by the photon detector in a measurement which projects the two quantum systems into an entangled state. The optical path may, for example comprise optical resonators (e.g. photonic cavities) that are each coupled to one of the quantum systems, an optical waveguide that extends between the two optical resonators and one or more couplers or switches configured to deliver photons from the photon source into the optical path and to deliver photons from the optical path into the photon detector.

“Heralded entanglement protocol” describes a protocol for entangling quantum systems that includes one or more measurements for which outcomes of the one or more measurements indicate whether or not execution of the protocol succeeded in entangling the quantum systems.

“Entanglement graph” is a graph that indicates the topology of a network of quantum systems. An entanglement graph includes vertices that are connected by edges. A vertex corresponds to a quantum system, a node comprising one or more quantum systems, node or a local group of quantum systems. Each edge extends between two vertices and indicates that there is at least one pair of quantum systems with one member of the pair associated with each of the vertices that can be directly entangled. In some embodiments an entanglement graph includes values of one or more parameters that are associated with each of the edges. The parameters may, for example include parameters that relate to characteristics of hardware that is being used to implement the edge such as:
probability of loss of photons on optical paths that correspond to the edge,
a measure of availability of hardware that implements the edge (e.g. where an edge corresponds to a dedicated Bell state analyzer the edge may be associated with a parameter that indicates a higher availability while an edge that corresponds to a Bell state analyzer that is used with an optical switching network to implement several different edges may be associated with a parameter that indicates lower availability); and/or
a measure of fidelity of entanglement created by direct entanglement corresponding to the edge.

In cases where plural configurations of the hardware correspond to the same edge then the parameters may include a set of parameters corresponds to each of the plural configurations. Parameters associated with edges of the entanglement graph may be available for access by a controller which may use the parameters in optimizing the creation of entanglement to support a quantum informatics program.

“Node” (or “cell”) refers to a part of a hardware network that includes one or more quantum systems that can support a qubit state that may be used in a quantum informatics process. For example, a node may include a plurality of quantum systems that can each support a qubit state. In some embodiments a node comprises at least one luminescent center in a substrate that can store two or more qubit states. In some embodiments nodes include intra node optical networks that are configurable to transfer quantum information within the node and/or to create entanglement of different quantum systems within the node. Nodes optionally include components such as optical switches, measurement devices, etc.

“Program of quantum informatics processing” is any machine readable information that sets out an algorithm for information processing that includes at least some quantum operations on quantum systems. Such a program may, for example set out an algorithm for a quantum computation. A program of quantum informatics processing may, for example, comprise information that defines a quantum circuit that may be implemented by a sequence of operations on quantum systems or information that specifies a sequence of operations on quantum systems.

“Qubit” means a quantum system that has first and second quantum states that can be used to represent quantum information and which can exist in a quantum superposition. A qubit can be provided by a two level quantum system such as an electron spin, a nuclear spin, or a photon (a “physical qubit”). Examples of quantum systems that may be used as qubits include particles that have spin (e.g. electrons, atomic nuclei, holes) where different spin states may represent information; particles that have excitonic states where the absence or presence of an exciton may represent information, particles e.g. electrons that have different orbital states where the orbital state occupied by the particle represents information, photons which can have different polarization or time bin states, and so on.

“Virtual qubit” is an abstract two-level quantum system. For example a program of quantum informatics may directly or indirectly specify operations to be performed on virtual qubits. The program may be realized by performing operations on physical qubits in a quantum network. In some cases, a program of quantum informatics manipulates values of logical qubits. The program may implement a logical qubit by a plurality of virtual qubits. For example, a particular computational quantum state for a logical qubit may be mapped to quantum states of two or more virtual qubits according to a quantum error correction code. The mapping may allow the computational quantum state to be recovered even if quantum states of one or more of the virtual qubits develop errors. To execute a program of quantum informatics, virtual qubits specified by the program may be mapped to physical qubits. A single virtual qubit may be realized by a single physical qubit or, in some cases by two or more physical qubits. Hardware used to execute a program may include qubits in addition to qubits that are mapped to virtual qubits. The additional qubits may aid with the quantum computation but are not themselves used to store valuable quantum information.

“Qudit” means a quantum system that has three or more quantum states that can be used to represent quantum information and can exist in quantum superpositions. A particle having a spin greater than ½ may, for example be applied as a qudit.

“Qutrit” is a qudit that has three quantum states for representing quantum information.

“Broker quantum system” means a quantum system that is applied as a conduit to transfer a quantum state to another quantum system (client quantum system). The quantum state may be transferred using a deterministic protocol or a probabilistic protocol for which there is a high probability that the transfer will be successful.

“Client quantum system” means a quantum system that receives transfer of a quantum state from a broker quantum system.

“Quantum system” means a system that has practical application for storing and/or manipulating quantum information. A quantum system supports plural quantum states and superpositions of at least two supported quantum states. Examples of quantum systems are spins (e.g. electron spins, nuclear spins), qubits, qutrits, quantum dots, damage centers such as T, I and M centers, NV centers, impurity atoms in silicon or other substrates, trapped ions, Josephson junction superconducting qubits, photons, and collections of two or more of these. In some embodiments, quantum systems are used as qubits. For example, a quantum system may consist of or include a spin that has two spin states and the spin may be used as a qubit to store and manipulate information that is represented by individual ones or superpositions of the two spin states.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Constructions for Quantum Optical Networks

One aspect of the present technology relates to construction and operation of a distributed network of quantum systems that may be used to process quantum information. Each quantum system may store information in a quantum state of the quantum system. The quantum system may, for example, comprise two or more basis states. In general, the quantum state of the system may be represented by:

$${\vert ψ 〉 = {\sum }_{i = 1}^{Q} {α}_{i} \vert φ 〉}_{i}$$

where: |ψ [symbol] is the quantum state, Q is the number of basis states, αᵢ are complex coefficients, and |φ [symbol] ᵢ are the basis states. Importantly the quantum state |ψ [symbol] may be a superposition (linear combination) of the basis states |φ [symbol] ᵢ.

In many applications quantum informatics uses two basis states of a quantum system to store quantum information. In such cases the quantum system may be referred to as a qubit. The quantum state of a qubit may be represented by a point on the Bloch sphere.

An example of a physical system that may be used as a qubit is a particle that has intrinsic spin of ½ (e.g. an electron, a hole or some nuclear spins). In such particles the basis states can be “spin up”, represented by |↑ [symbol] and “spin down”, represented by |↓ [symbol] . Another example of a quantum system that may be used as a qubit is a photon, in which case the basis states may comprise polarization states, time bin states, or states involving other photon properties.

Quantum information may be processed by applying operations to quantum systems. Examples of operations that may be applied in quantum informatics include:
Entanglement operations which cause quantum states of two or more distinct qubits to be coupled such that the combined state of the distinct qubits cannot be described by the state of each of the distinct qubits individually.
Measurement operations which measure the state of a qubit. Depending on the state of the qubit, the measurement could cause a change in the state of the qubit.
Initialization operations which set a qubit to a specific state.
Single qubit gates which change the state of a single qubit.
Two qubit gates which operate on two qubits. Examples of two qubit gates include: controlled gates such as CNOT gates, controlled phase gates, in which a single qubit gate operates on one qubit depending on the state of a second qubit; SWAP gates in which the states of two qubits are traded so that the final state of the first qubit is the initial state of the second qubit and vice versa.
Multi-qubit gates that operate on two or more qubits. For example: the Toffoli gate which operates on three qubits.

The steps required to apply any of the above operations to a specific qubit depend on the nature of the qubit.

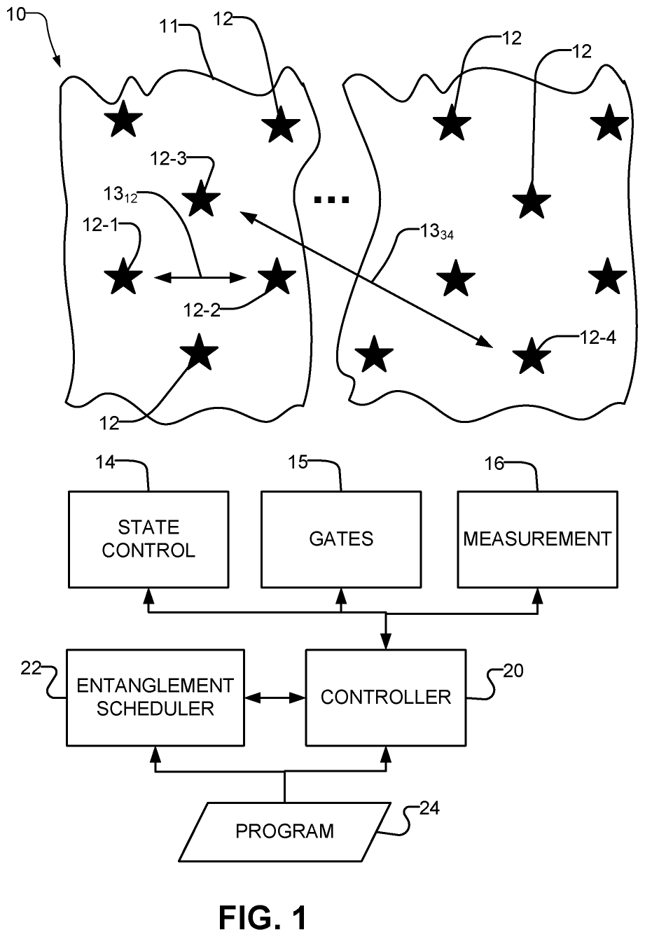

FIG. 1 is a conceptual drawing illustrating an example quantum network 10 that may be used in quantum informatics. Network 10 includes a plurality of quantum systems 12. Quantum systems 12 are matter-based systems. Apart from being matter-based there is no limitation that quantum systems 12 be of any particular type or have any particular structure. The conceptual arrangement illustrated in FIG. 1 may include any kind or kinds of matter-based quantum systems that are capable of storing quantum information. FIG. 1 does not mandate any particular spatial arrangement of quantum systems 12.

Network 10 includes a system 14 operative to set quantum states of individual quantum systems. The mechanics of system 14 depend on the nature(s) of quantum systems 12. For example, system 14 may include sources of electromagnetic radiation (e.g. optical radiation, radiofrequency radiation (e.g. microwave radiation) which are operable to set the quantum states of individual quantum systems 12 by applying radiation, e.g. continuously for a period of time and/or as series of pulses. System 14 may additionally include mechanisms operable to control the responses of individual quantum systems 12 to radiation. These mechanisms may, for example, set parameters of an electric field, a magnetic field, and/or strain in a substrate at a location of the quantum system 12. These mechanisms may, for example, operate by altering energy eigenstates of the quantum system 12.

Network 10 includes a system 15 for applying quantum gates to quantum systems 12. The quantum gates may include gates that act on single quantum systems 12 and/or gates that act on plural quantum systems 12. The mechanics of system 15 depend on the nature(s) of quantum systems 12.

Network 10 includes a system 16 for making measurements of quantum states of quantum systems 12. The measurements may be measurements made on individual quantum systems 12 (e.g. measurements of spin relative to defined axes, Pauli measurements etc.) and/or measurements of joint states of two or more quantum systems 12 (e.g. Bell state measurements).

A controller 20 is configured to coordinate the operation of systems 14, 15 and 16 to perform quantum informatics processes using quantum systems 12.

As the field of quantum informatics develops there is a demand to provide quantum networks that include larger numbers of physical quantum systems to facilitate a wide range of quantum informatics applications.

Network 10 is not limited to application for any particular quantum computing methodology. Universal quantum computing or useful specific quantum computing processes are possible by appropriate combinations of initializing quantum systems 12, applying quantum gates and/or making measurements. Many quantum computing algorithms require one or both of gates that operate on two or more quantum systems and/or measurements of the combined states of two or more quantum systems. Applying such gates and/or making such measurements requires some connectivity or interaction between different ones of quantum systems 12. Where two quantum systems 12 are located in close physical proximity (conceptually illustrated by 1312 in FIG. 1) then local interactions such as local magnetic or electromagnetic interactions, Zeeman interactions and/or hyperfine interactions may be exploited to apply gates that affect plural quantum systems 12 and/or make measurements regarding the combined states of plural quantum systems 12.

As the number of quantum systems 12 in network 10 is increased it becomes impractical for all of the quantum systems 12 to be in close enough proximity to rely on local interactions to facilitate applying quantum gates to plural quantum systems 12 and/or making measurements of the combined states of plural quantum systems 12. For example, local interactions may not be useful where quantum systems 12 are separated by longer distances (conceptually illustrated by 1334 in FIG. 1). This problem may be solved by the use of quantum entanglement.

Quantum entanglement may be applied, for example to:
teleport the quantum state of a first quantum system 12 to a second quantum system 12; and/or
teleport a two quantum system quantum gate so that the gate acts on first and second quantum systems 12;
where the first and second quantum systems 12 are separated by an arbitrary distance.

Various protocols for generating entanglement among quantum systems are known. One example of entanglement protocol is described in S. D. Barrett and P. Kok, Phys. Rev. A 71, 060310(R) (2005) which is hereby incorporated herein by reference for all purposes. This protocol operates by causing each of first and second quantum systems 12 to emit a photon state that is itself entangled with the quantum state of the quantum system which emitted the photon. The photons are each generated in a way that results in the quantum state of each of the photons (“photon state”) being entangled with the quantum state of the quantum system 12 from which the photon was emitted. The photons are respectively directed to first and second input ports of a Bell state analyzer (BSA). In some embodiments the created entanglement is a maximally or near-maximally entangled state such as a Bell state.

A typical BSA comprises first and second input ports that are respectively connected to receive a photon from a first quantum system 12 and a second quantum system 12. The input ports deliver the respective photons to an interference device such as a beamsplitter or Mach-Zehnder interferometer that allows the photons to interfere with one another. First and second output ports of the interference device are respectively connected to first and second single photon detectors. The BSA may be used to entangle the quantum states of the first and second quantum systems in a heralded entanglement protocol. A BSA may also be used to detect photons in order to make measurements on a quantum system.

The resulting entanglement of the first and second quantum systems 12 may be applied to perform quantum operations, for example, to teleport the quantum state of one of quantum systems 12 to another quantum system 12 or to teleport a two-qubit quantum gate such that the gate is applied between two quantum systems 12 that are not necessarily local to one another. Systems 14 and/or 15 of network 10 may incorporate BSAs.

It is not mandatory that qubits in quantum networks as described herein be of a type that can be caused to emit optical photons. Quantum networks that include quantum systems that emit in other regions of the spectrum (e.g. in the microwave range) may be used. In some embodiments a suitable transducer that generates an optical photon state (e.g. in the near infrared) that replicates information from the quantum state of the emission is used. Entanglement between two such quantum systems may be achieved by an entanglement protocol that includes performing a Bell state measurement on microwave photons or on transduced optical photon states. For example, superconducting Josephson junctions may be used as qubits. Microwave photon states emitted by superconducting qubits may be converted to optical photon states by transduction, for example using apparatus as described in PCT international patent publication WO 2022/020951 which is hereby incorporated herein by reference for all purposes.

Networks may have different topologies. A topology may specify how many nodes belong to a network and for which pairs of those nodes quantum systems of the nodes can be directly entangled. The same topology may be realized using many different hardware designs.

Some networks have topologies that provide “all-to-all” connectivity. In this context “all-to-all” connectivity means that the network 10 is configured to permit quantum systems 12 of any pair of nodes in the network 10 to be entangled directly. An all-to-all connected network includes a mechanism or mechanisms that is operable for directly entangling quantum systems belonging to any pair of the nodes of the network. For example, a network 10 may provide optical paths that are configured or configurable to optically connect two quantum systems 12 in any two nodes of the network to a common BSA. It is not necessary that there is a one to one correspondence between edges of an entanglement graph and specific hardware components or configurations. In some embodiments the hardware of a quantum network is constructed and/or configurable such that for at least some pairs of nodes of the network there are two or more (possibly many more) different paths and/or configurations of the network that are operable to generate entanglement between the pair of nodes of the network.

Larger all-to-all connected networks can have some disadvantages. A network 10 that has N nodes has

$$\frac{N \times ( N - 1 )}{2}$$

distinct pairs of nodes. This number increases quickly as N increases. Providing all-to-all connectivity becomes increasingly technically complicated as N increases. Also at least some arrangements of optical components for providing all-to-all connectivity can exhibit greater photon loss as N increases.

It is not necessarily for nodes of a network to be all-to-all connected. As an alternative to providing “all-to-all” connectivity a network 10 may be configured such that the network includes some pairs of quantum systems 12 that cannot be directly entangled. Using a network topology that is not all-to-all connected may be beneficial in some cases for reducing hardware costs, simplifying hardware, and reducing photon losses. One can simplify the construction of a network 10 by not providing all-to-all connectivity at the cost of creating the additional entanglement required for entanglement swapping.

Entanglement swapping may be performed to entangle a pair of quantum systems 12 even if the network does not allow the pair of quantum systems 12 to be directly entangled. One can entangle two quantum systems 12 by entanglement swapping if it is possible to entangle a number of pairs of quantum systems 12 (a “chain”) that form a path such that the two quantum systems 12 to be entangled (“endpoint quantum systems”) are at opposite ends of the chain. With this approach one can create pairs of entangled quantum systems 12 to form such a chain and then entangle the two endpoint quantum systems 12 by entanglement swapping. The entanglement of each entangled pair in this chain ends up being consumed in order to create entanglement between the endpoint quantum systems.

Entanglement swapping allows quantum system(s) in one node to be used to form entanglement between quantum systems of two other nodes that are not directly connected. For example, if a qubit in a node A and another qubit in a node C can each be directly entangled to one of two qubits in a node B then entanglement swapping may be applied to entangle the qubits of nodes A and C by first creating entanglement between the qubits of nodes A and C with a corresponding one of the two qubits of node B. Then entanglement between the qubits of nodes A and C may be created by swapping entanglement from nodes A&B and B&C to create entanglement between quantum systems of nodes A&C using the qubits in node B. After entanglement has been established between nodes A and C the qubits of node B that were used as mediators to achieve the entanglement of nodes A and C may be used for other purposes. If another node D has a quantum system that can be directly entangled with a qubit of node C then another entanglement swap could be performed to extend the entanglement to be between nodes A and D. Entanglement swapping does not require that the final entanglement is between quantum systems of nodes for which there is any mechanism capable of directly creating entanglement between quantum systems of those nodes.

For example, consider the case where it is desired to entangle first and fourth quantum systems 12 by entanglement swapping. One might entangle the first quantum system with a second quantum system and entangle the fourth quantum system with a third quantum system. One can then cause the first and fourth quantum systems to be entangled. This entanglement swapping may, for example, be done by performing a Bell state measurement between the second and third quantum systems. If the Bell state measurement heralds success, conditional single qubit gates based on the result of the Bell state measurement are applied to the second and/or third quantum systems. The result is that the entanglement between the first and second quantum system and the entanglement between the third and fourth quantum system are consumed to yield the desired entanglement between the first and fourth quantum systems.

In some embodiments, each node comprises one or more quantum systems. A node may comprise plural quantum systems. In some embodiments nodes include local mechanisms for entangling quantum systems of the node that may be distinct for mechanisms provided to entangle quantum systems that belong to different nodes. Nodes may also include other mechanisms such as mechanisms for manipulating states of quantum systems of the node, applying quantum gates to the quantum systems of the node, making measurements of quantum systems of the node or photons generated within or received at the node.

The network connects the nodes and facilitates creating entanglement of quantum systems of different ones of the nodes. The resulting entanglement may be used to transfer a quantum state from one node to another and/or to execute two qubit quantum operations on qubits provided by quantum systems in different nodes.

From the above discussion it can be seen that quantum entanglement may be used to facilitate efficient operation of a quantum network 10 to perform quantum computing or other quantum informatics processes. However, to make effective use of entanglement it is not sufficient that some quantum systems somewhere in a network 10 are entangled. For entanglement to be usefully applied at any stage of a quantum informatics process it is necessary that the entanglement be among the specific ones of quantum systems 12 in the network that are situated such that their entanglement can be consumed to advance the process. Which pairs or groups of quantum systems 12 should be entangled to most effectively advance a process depends in general on the nature of the process and the current stage of the process.

### Entanglement Scheduling

One aspect of this invention provides an entanglement scheduler 22 that is operative to look ahead to plan entanglement to advance a quantum informatics process, quantum networks that include an entanglement scheduler, and entanglement scheduling methods.

To execute a desired quantum informatics program on a particular quantum network it may be necessary or desirable to provide quantum entanglement to support one or more operations of the program. To provide the required entanglement it is necessary to know which quantum systems of the network should be entangled. This can depend on what operations are included in the program, the mapping of logical qubits of the program to physical qubits in the network, the topology of the network (which may be defined by an entanglement graph) as well as whether resources that would be required to generate entanglement of any given pair of quantum systems will be available at the time that the entanglement should be generated.

An entanglement scheduler may be provided to coordinate generation of entanglement in order to support a quantum informatics program. Entanglement scheduler 22 is configured to predict what entanglement will be needed at future times and/or prioritize attempts to achieve specified entanglements at future times in order to facilitate execution of a specified program 24 of quantum informatics processing. Entanglement scheduler 22 may control a quantum network to achieve the entanglement.

A quantum informatics program to be executed may be input into a compiler that processes the program to yield output that specifies operations to be performed on virtual qubits to execute the program. The output may additionally include criticality information regarding the criticality of individual operations or groups operations. The criticality information may, for example indicate a degree to which error introduced by a particular operation is likely to affect a result of the program and/or a degree to which any errors introduced in executing an operation can be compensated for in other parts of the program and/or a level of fidelity of a quantum state or quantum states to be produced by executing the operation.

In some embodiments, entanglement scheduler 22 is configured to take into account one or more of a range of factors in deciding how to provide any entanglement that may be necessary or desirable to support execution of a particular quantum informatics program. These factors may, for example, include any or all or any combination of the following factors:
when is it expected that a particular operation that requires entanglement will be executed?
how long will it likely take to generate the required entanglement?
what different ways are there to produce the entanglement (e.g. directly entangle two quantum systems; entangle the two quantum systems by entanglement swapping using any of one or more entanglement chains; use entanglement that already exists to provide entanglement of the two quantum systems and/or to provide one or more links in one or more entanglement chains that may be used to provide the required entanglement by entanglement swapping); and/or combine a number of entangled pairs by performing an entanglement distillation process?
what is the probability that an individual attempt to entangle two quantum systems will succeed? This can depend on factors such as the entanglement protocol that will be used, the degree of lossiness of any optical paths that will be used in creating the entanglement and, where entanglement swapping will be used, the number of entangled pairs of quantum systems in an entanglement swapping chain.
what fidelity of entanglement is required by the operation?
how critical is the entanglement itself or the operation supported by the entanglement to the program?
will hardware resources that may be used to generate the entanglement (e.g. optical paths through an optical switching network, measurement devices such as photon detectors, BSAs, optical sources, signal generators etc.) be available? Such hardware resources may be temporarily unavailable because, for example, they are being used for some other purpose and/or they are part of a larger hardware system that may from time to time be configured so that the availability of certain hardware resources for generating entanglement of certain quantum systems is temporarily blocked.
what are the characteristics of the quantum systems that will be entangled (e.g. decoherence time)?
will there be “noise” (e.g. from operations on other quantum systems) that may affect the fidelity of the entangled state?

Entanglement scheduler 22 may have access to various sources of data such as one or more of data that specifies:
operations to be applied to quantum systems 12 If a network 10;
a topology of a network 10;
lossiness of optical paths in the network 10 (e.g., degree of lossiness);
hardware resources of network 10;
current and projected configurations of hardware resources of network 10 (e.g. configurations of optical switches, commitments of resources such as measurement instruments to specific tasks;
projected availability of hardware resources of the network 10;
characteristics of quantum systems (e.g. decoherence times);
crosstalk characteristics (e.g. the effect of initializing one quantum system 12 on the fidelity/coherence of other quantum systems 12);
photon propagation times;
etc.

The number of pairs of entangled quantum systems that may be required or desirable to support any particular operation can depend on the connectivity of network 10.

Where optical paths used to create entanglement include components, such as optical switches, for example to allow one BSA to be selectively connected to any of a plurality of pairs of quantum systems 12 then the presence of such components tends to make the optical paths lossier. In addition, depending on the construction of hardware in a network (e.g. optical switches, BSAs, photon detectors etc., as applicable), configuring the network to generate entanglement of one pair of quantum systems may temporarily block generation of entanglement of other pairs of quantum systems (e.g. a configuration of optical switches that may be used to provide optical paths between each of a first pair of quantum systems and a BSA may be incompatible with providing optical paths between each of a second pair of quantum systems to a BSA).

Entanglement scheduler 22 may operate to create entanglement prior-to and during the run-time execution of a quantum informatics process on a network 10. Entanglement scheduler 22 may prioritize, and schedule entanglement attempts based on upcoming requirements for entanglement to implement a quantum informatics process (e.g. a quantum circuit).

Entanglement scheduler 22 may manage hardware (e.g. a network 10) by keeping track of an entanglement inventory while prioritizing and scheduling entanglement attempts and resource allocation based on the available hardware, a given network topology, and future requirements of entanglement to implement a quantum informatics process.

Entanglement scheduler 22 may, for example, comprise a data processor of any suitable type. In some embodiments the data processor comprises a classical computer and fast electronics like a field programmable gate array (FPGA). Entanglement processor 22 may be integrated with controller 20 or separate.

Controller 20 is connected to control the overall operation of a quantum network 10. Controller 20 may implement commands received from entanglement scheduler 22 (e.g. commands to execute a sequence of operations according to an entanglement protocol to entangle quantum states of two quantum systems 12).

Controller 20 and/or entanglement scheduler 22 may be implemented by one or more of specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors and controlling elements of control system 20 according to the software instructions.

Details of the interface of controller 20 and entanglement scheduler 22 to quantum systems of a network 10 depend on the nature of the quantum systems and the construction of network 10. Such an interface may, for example, comprise a low level interface layer that directly controls devices that affect quantum states of the quantum systems of the network and an intermediate layer that generates specific commands for the low interface layer based on higher level commands from entanglement scheduler 22 and/or controller 10. In some embodiments the low level interface layer also controls optical switches to provide desired optical connectivity.

For example, scheduler 22 and/or controller 10 may command that a particular gate be applied to a particular quantum system of network 10. Based on this command the intermediate interface layer may generate one or more commands to cause certain devices to apply a specific type of pulse sequence to the quantum system in order to implement the gate. The low level interface layer may directly control the device to deliver the commanded pulse sequence.

Which particular devices are included in network 10 will depend on the construction of network 10 and the nature of the quantum systems. Such devices may, for example include devices such as lasers, power supplies, magnets, radiofrequency sources, photon detectors, optical switches etc.

In some embodiments fast analog electronics are used to implement the low interface layer. In some embodiments digital electronics are used to implement the intermediate interface layer.

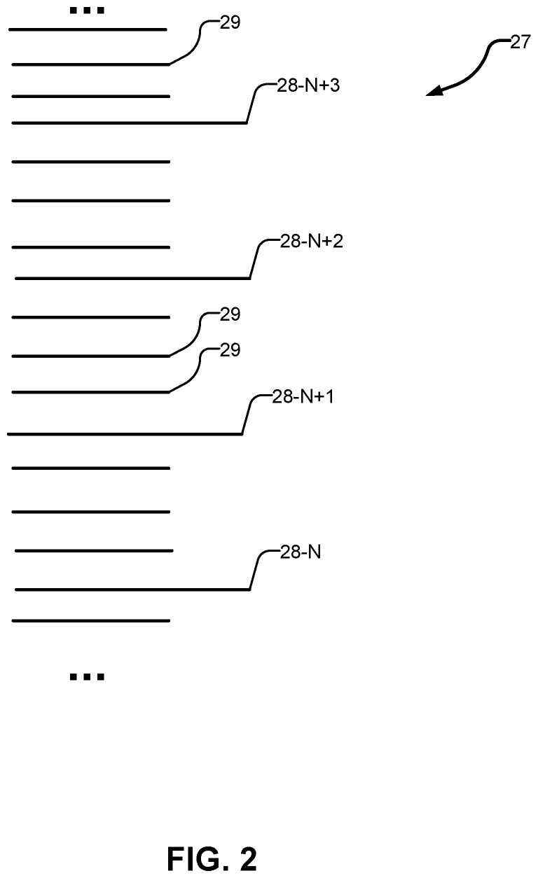

Program 24 may be specified in any of various ways but may be considered, in general, to be made up of or to define a sequence of execution stages 28 (see FIG. 2). In each execution stage 28 various operations may be scheduled to take place (e.g. initializing one or more quantum systems 12 into specified quantum states, applying quantum gates to one or more quantum systems 12 or groups of two or more quantum systems 12, making measurements on one or more quantum systems 12 or groups of two or more quantum systems 12 etc.). Some of these operations may be of types that require entanglement to exist to facilitate the operation (e.g. teleporting a quantum state from one quantum system 12 to another quantum system 12 or teleporting a two qubit quantum gate to act on two quantum systems 12). FIG. 2 schematically illustrates a portion of an example schedule 27 which includes execution stages 28 which are individually labelled as 28-N, 28-N+1, etc., that are spaced apart in time.

Entanglement scheduler 22 works to create entanglements that are required to support operations in upcoming execution stages 28. In some embodiments entanglement scheduler 22 receives information (e.g. as part of program 24) that specifies the required entanglements. In some embodiments entanglement scheduler 22 processes a schedule 27 to identify operations that require entanglement in each execution stage 28. Entanglement scheduler 22 works ahead to generate entanglement to meet these needs.

In some embodiments specific operations are scheduled to be executed in certain execution stages 28. In such cases entanglement scheduler 22 may schedule attempts to create required entanglement to support the operations long enough before the corresponding execution stage 28 to provide a desired probability that the required entanglement will be generated before the corresponding execution stage 28. In some embodiments an operation may be executed as soon as: any required entanglement has been generated; and execution of the operation is not blocked by a requirement that some other operation be executed first or a hardware conflict that temporarily blocks execution of the operation.

In some embodiments entanglement scheduler 22 determines dependencies between operations. For example, one operation or group of operations must be complete before another operation can be performed); the operations of a certain set of operations are independent in the sense that the order in which these operations are performed is not important; execution of certain operations may be contingent on the results or on success or failure of one or more other operations; and so on. In some embodiments entanglement scheduler 22 uses such dependencies to identify entanglement that will be required or beneficial to support upcoming operations and to perform steps required to generate the entanglement in an order and at times such that execution of the operations of a quantum informatics program are not unduly delayed when they are otherwise ready to be executed because entanglement required to support the operations is not yet available.

Some embodiments combine two or more of the above functionalities, for example by:
scheduling one or more operations in certain execution stages 28 and configuring entanglement scheduler 22 to bring forward an operation for executed in an earlier execution stage 28 if any required entanglement is already available and execution of the operation is not blocked;
scheduling some operations for execution in certain execution stages 28 and executing some other operations as soon as any required entanglement is generated and the other operations are not blocked.
determining an order for performing different entanglement attempts based on dependencies of operations to be supported by the resulting entanglement and executing the entanglement attempts in the order.
executing operations in response to determining that: criteria based on dependencies of the operation on other operations are satisfied, any entanglement required to support the operation is available and the hardware is or can be configured to permit execution of the operation .e.g. configuring the hardware for executing the operation would not block execution of some other operation that has greater priority . . . .

Entanglement scheduler 22 may use estimates of how many attempts are likely to be needed to achieve required entanglement in order to determine how far in advance to commence generating the required entanglement. Such estimates may be calculated during runtime or pre-calculated and looked up. Entanglement scheduler may, for example, commence entanglement attempts to support a particular operation:
at a calculated time prior to scheduled or anticipated execution of the relevant operation;
when a number of other operations to be executed prior to the relevant operations reaches a certain number; and/or
a calculated number of entanglement generation stages 29 prior to scheduled execution of the relevant operation.

Establishing entanglement between two quantum systems may take more than one entanglement attempt. One reason why this can be the case is that some entanglement protocols are inherently probabilistic (i.e. any attempt at creating entanglement may have a probability of success that is less than 100%). Consequently, on average it may be necessary to attempt entanglement more than once to achieve entanglement of two quantum systems using such a protocol even if conditions are ideal. Also, where an entanglement protocol is mediated by photons, loss of a photon can cause the entanglement attempt to fail. The average number of attempts required to achieve entanglement of two quantum systems by a protocol that involves travelling photons may increase as the optical paths taken by photons in implementing an entanglement protocol become more lossy. Typically, optical paths become lossier with increased length. In addition to all of the above, practical entanglement protocols typically require initialization of the quantum states of participating quantum systems followed by a number of additional steps and there is a possibility that errors will be introduced in executing the protocol as a result of interference (“noise”) and/or other factors. Consequently, the number of entanglement attempts needed to successfully entangle any particular pair of quantum systems may generally not be known in advance.

An entanglement scheduler 22 may compute a number such that there is a given probability of successful entanglement of two quantum systems without exceeding the number of entanglement attempts. For example, if for a given pair of quantum systems, due to a probability of photon loss and a probabilistic entanglement protocol the probability that any single entangle attempt will succeed is, p, then the number of entanglement attempts n to achieve a desired probability P of successful entanglement is given by:

$$1 - {( 1 - p )}^{n} = P$$

for the case of p=0.00015 and P=0.99, n=30,699 (i.e. there is a 99% likelihood that entanglement will be achieved before reaching the 30,700^{th} entanglement attempt).

The number of entanglement attempts required to achieve entanglement of two quantum systems with a desired probability in a case where entanglement swapping will be used can be determined based on: a number of entanglement attempts to entangle each pair of quantum systems in an entanglement chain (e.g., entanglement swapping chain) with a given probability (e.g. as described above); and a number of attempts to successfully complete each entanglement swapping operation with a desired probability given the probability of success for each attempt at the entanglement swapping operation.

For example, consider the case where an entanglement chain has three segments (each segment comprising a pair of quantum systems that will be entangled) which will be used to generate entanglement of quantum systems at opposing endpoints of the chain by two entanglement swaps. Suppose that it is desired to specify a set of entanglement attempts within which there is a 99% probability that entanglement of the end quantum systems of the chain will be achieved. In this case, it is necessary to budget to try each entanglement swap enough times that the probability of successful completion of the entanglement swap will be about 99.5% (for a combined probability of success of 99%). For the case where each entanglement swap has a probability of success of 0.4, to achieve a 99.5% likelihood of success requires 11 entanglement attempts. If an attempted entanglement swap fails then it is necessary to regenerate the entanglement between the pairs of quantum systems that participate in the entanglement swap.

Suppose that to achieve entanglement of the quantum systems of the first, second and third segments of the chain with a probability of 99.8% can be achieved within 50 tries, 70 tries and 100 tries respectively. In this example the entanglement scheduler might budget for up to 11×(11×(50+70+1)+100+1)=15752 individual entanglement attempts to achieve entanglement of the quantum systems that are at the endpoints of the entanglement chain with a desired probability of close to 100%. In some cases, some of these entanglement attempts may be performed in parallel. In some embodiments a controller is configured to determine a sequence of entanglement attempts to implement an entanglement swapping chain such that, entanglement attempts that have higher probability of success are performed later, thereby reducing the total number of entanglement attempts that will likely be required to create entanglement of endpoints of the entanglement swapping chain.

In some embodiments, one or more steps of entanglement swapping can be performed by deterministic operations. Deterministic operations have a probability of success approaching 100%. This can dramatically reduce the total number of entanglement attempts required to achieve entanglement of the quantum systems that are at the endpoints of the entanglement chain with a desired probability. For example, if the above example is modified so that each entanglement swap is performed deterministically (requiring only one attempt) then the number of entanglement attempts required to achieve a likelihood of about 99.8% of achieving successful entanglement of the quantum systems at endpoints of the entanglement chain are reduced from 15752 individual entanglement attempts to only 222 entanglement attempts.

In some embodiments, adjacent segments of an entanglement chain terminate at quantum systems that are closely coupled such that an entanglement swap may be achieved deterministically (e.g. by applying one or more deterministic quantum gates to the closely coupled quantum systems. In some embodiments the closely coupled quantum systems are both part of an arrangement of atoms, such as a luminescent center, that has a defined atomic structure. For example, each of the closely coupled quantum systems may be provided by an intrinsic spin of the arrangement of atoms (e.g. an electron spin or a nuclear spin or a hole spin. In some embodiments the quantum systems comprise spins of a T centre in silicon.

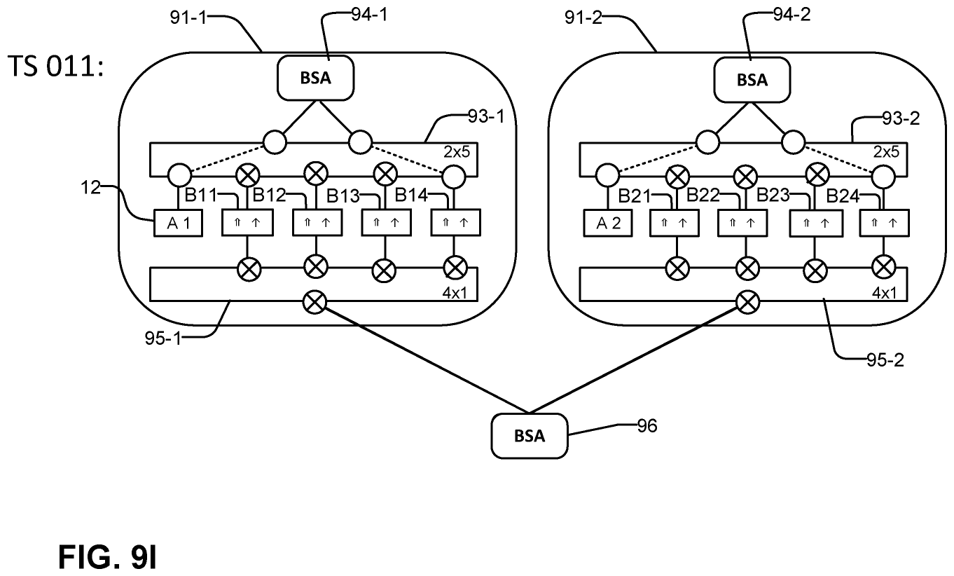

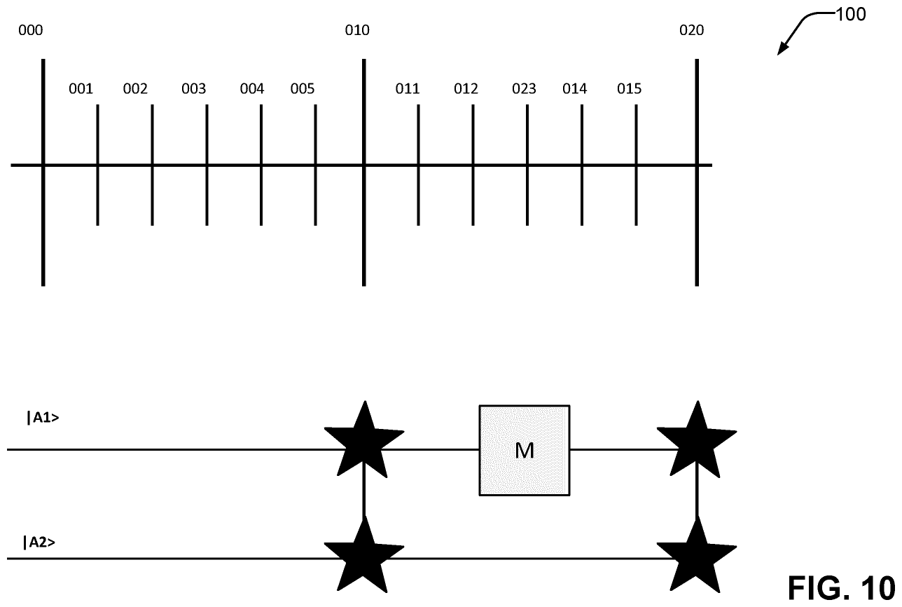

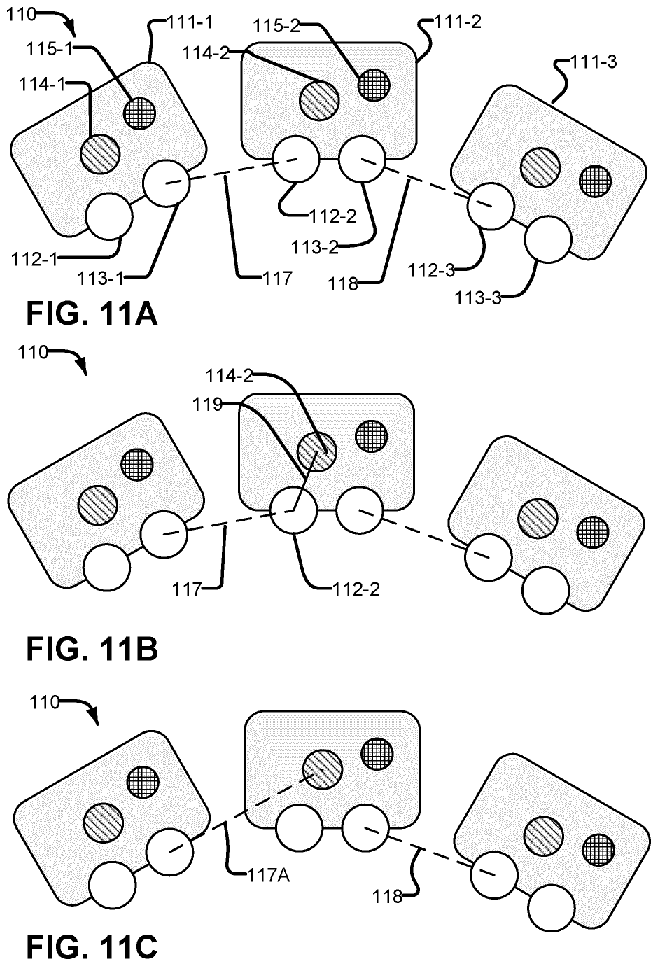

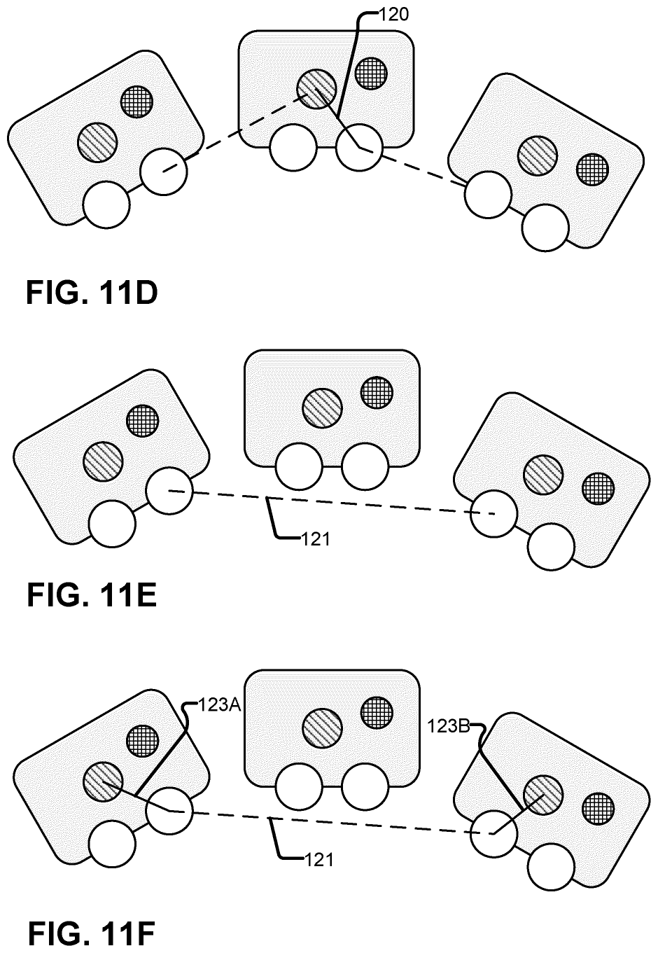

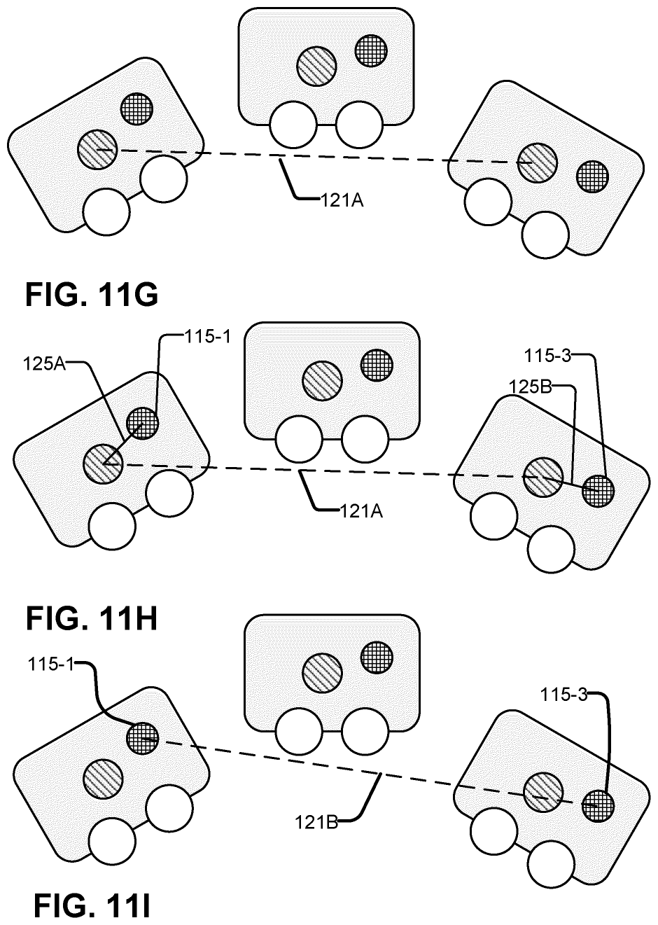

FIGS. 11A to 11I are schematic sketches that illustrate a portion of a quantum network 110 at different stages in an example method which involves entanglement swapping using deterministic operations. The illustrated part of quantum network 110 includes nodes 111-1, 111-2 and 111-3 (generally and collectively nodes 111). Each of nodes 111 includes four quantum systems generally and collectively referred to as quantum systems 112, 113, 114 and 115. For example, node 111-1 includes quantum systems 112-1, 113-1, 114-1 and 115-1, node 111-2 includes quantum systems 112-2, 113-2, 114-2 and 115-2 and so on.

Quantum systems 112 and 113 are “network” quantum systems which are optically connectable for interaction with network quantum systems of other nodes 111. For example, a quantum system 112 or 113 of a first node 111 and a quantum system 112 or 113 of a second node 111 may be optically coupled to a BSA which may be used in performing a probabilistic entanglement protocol to entangle the quantum systems of the quantum systems of the first and second nodes.

Quantum systems 113 and 114 are internal to nodes 111. In some embodiments, nodes 111 are constructed so that quantum systems 114 and 115 are isolated from (e.g. not directly connected to) optical paths external to the respective node 111. In some embodiments, quantum systems 114 and 115 are respectively provided by an electron spin and a nuclear spin of a T centre.

In this example it is desired to create entanglement between quantum systems 115-1 and 115-3. As shown in FIG. 11A, in preparation for providing the desired entanglement, two segments 117, 118 of an entanglement swapping chain have been created by respectively entangling quantum states of quantum systems 113-1 and 112-2, and quantum systems 113-2 and 112-3. As shown in FIG. 11B, a SWAP gate 119 (indicated by a solid line) is applied to quantum systems 112-2 and 114-2. SWAP gate 119 swaps quantum states of quantum systems 112-2 and 114-2 with the result that the entanglement of segment 117 is transferred to entanglement 117A of quantum systems 113-1 and 114-2 as shown in FIG. 11C.

Entanglement 121 of quantum systems 113-1 and 112-3 (see FIG. 11E) may then be created by entanglement swapping which consumes the entanglement of segments 117 and 118. The entanglement swapping may be done using deterministic operations. For example, the entanglement swapping may be performed by performing a BSM 120 between quantum systems 112-2 and 114-2 (see FIG. 11D).

Performing BSM 120 may, for example, comprise applying a CNOT gate where one of quantum systems 112-2 and 114-2 serves as a control and the other one of quantum systems 112-2 and 114-2 serves as a target and subsequently measuring the quantum states of each of quantum systems 112-2 and 114-2. Measurement of the one of quantum systems 112-2 and 114-2 that served as the control for the CNOT gate is performed in the X basis. Measurement of the one of quantum systems 112-2 and 114-2 that served as the target for the CNOT is performed in the Z basis. The Z basis may be the computational basis |0>, |1>. Where the quantum system is an electron spin the computational basis may be represented as |↑ [symbol] , |↓ [symbol] . Where the quantum system is a nuclear spin the computational basis may be represented as [symbol] , [symbol] . Measurement in the X basis may be performed by applying a Hadamard gate followed by measurement in the Z basis.

In some embodiments measuring the quantum states of quantum systems 112-2 and 114-2 comprises measuring the quantum state of one of quantum systems 112-2 and 114-2, applying a SWAP gate to quantum systems 112-2 and 114-2, and then measuring the state of the same one of quantum system 112-2 and 114-2 again. This can be advantageous, for example, in cases where quantum system 112-2 is an electron spin and quantum system 114-2 is a nuclear spin since both measurements may be made on the electron spin, which measurements may be performed more easily and/or with more reliable measuring apparatus than equivalent measurements on the nuclear spin.

Entanglement 121 of quantum systems 113-1 and 112-3 may be transferred to be entanglement 121A between quantum systems 114-1 and 114-3 (see FIG. 1G) by performing BSMs 123A and 123B respectively between quantum systems 113-1 and 114-1 and between quantum systems 113-3 and 114-3 as indicated in FIG. 11F. BSMs 123A and 123B may be made concurrently or in any order.

Entanglement 121A may be transferred to entanglement 121B between quantum systems 115-1 and 115-3 (see FIG. 11I) by performing BSMs 125A and 125B respectively between quantum systems 114-1 and 115-1 and between quantum systems 114-3 and 115-3 as indicated in FIG. 11H. BSMs 125A and 125B may be made concurrently or in any order.

The operations corresponding to SWAP gate 119 and BSMs 120, 123A, 123B, 125A and 125B are intra-node operations (i.e. operations that take place within one node 111). Consequently, these operations tend to be more reliable (have a lower probability of failure) than similar operations performed between nodes (“inter-node operations”). In some embodiments some or all of these operations are deterministic.

Entanglement swapping may also be used to create entanglement of pairs of quantum systems 12 that could be directly entangled. This can be advantageous in cases where the optical paths available for directly creating entanglement have a relatively high probability of photon loss such that creating direct entanglement may take many attempts as well as cases where hardware resources required for direct entanglement are temporarily unavailable (e.g. because those hardware resources are temporarily reserved for some other purpose). In some such cases, entanglement swapping may be faster and/or completed with fewer entanglement attempts than direct entanglement (at the cost of lower fidelity entanglement).

In some cases the fidelity of entanglement (i.e. how close the entanglement is to a maximally entangled state) is important. In selecting among possible ways to create required entanglement, entanglement scheduler 22 may take into account a desired level of entanglement fidelity. The fidelity of entanglement can depend on factors including the protocol by which the entanglement was created, whether the entanglement is achieved by direct entanglement or entanglement swapping, characteristics of the entangled quantum systems, the length of time that has passed since the quantum systems became entangled, and the magnitude of electromagnetic and other noise affecting the quantum systems. In some embodiments, entanglement scheduler 22 is configured to include performing entanglement distillation to provide a desired level of entanglement fidelity as an option for generating required entanglement.

Depending on the implementation, scheduler 22 may be configured to assign entanglement attempts and/or operations to predetermined stages (e.g. entanglement generation stages 29 and/or execution stages 28) and/or to proceed with entanglement attempts until entanglement to support the next operation or set of operations is available and to execute operations when conditions for executing the operations are satisfied. In either case, entanglement scheduler 22 may establish an order for performing entanglement attempts such that entanglement that may be desired or required to support each operations will be available when the operation is performed.

In some embodiments schedule 27 includes entanglement generation stages 29 located between execution stages 28. In some embodiments entanglement generation stages 29 are dedicated exclusively or primarily to generation of entanglement. In some embodiments each entanglement generation stage 29 can include plural entanglement attempts up to some maximum number of parallel entanglement attempts as determined by the design of network 10 and entanglement scheduler 22. In some embodiments, selection of entanglement attempts to be made in parallel takes into account hardware constraints that limit what entanglement attempts may be made in parallel.

In some embodiments entanglement scheduler 22 may additionally or in the alternative execute entanglement attempts in execution stages 28 to the extent that resources for performing those entanglement attempts can be allocated without interfering with the execution of operations to be executed in the execution stage 28.

The number of entanglement generation stages 29 included in schedule 27 may be set or dynamically varied depending on the amount of entanglement required and the typical number of entanglement attempts required to achieve entanglement. The typical number of entanglement attempts required to achieve entanglement may depend on the entanglement protocol being applied as well as factors such as the reliability (lossiness) of links that may be used to convey photons used by the entanglement protocol.

In some embodiments, execution stages 28 occur at times set by a clock cycle which may be called the “Instruction cycle” (IC). Between each execution stage 28 entanglement generation stages 29 occur at times set by a faster clock cycle which may be called an “entanglement attempt cycle” (EA cycle). The time between successive entanglement generation stages 29 may be set to be sufficient to perform an entanglement attempt and check whether the entanglement attempt succeeded or failed.

It is possible but not mandatory that the number of entanglement generation stages 29 between successive execution stages is fixed. It is possible but not mandatory that entanglement generation stages 29 are performed synchronously with execution stages 28.

In scheduling entanglement, entanglement scheduler 22 may take into account uncertainties regarding which particular quantum systems should be entangled to facilitate the operations in any future execution stage 28. The entanglement required to support specific operations that will be performed in any future execution stage 28 cannot always be known in advance. For example:
some programs 24 may include conditional branches such as feed-forward gates in a quantum circuit, conditional measurements, “if-else statements etc. such that the operations that will be performed in later execution stages 28 may be different depending on results obtained in earlier execution stages 28;
some operations may fail to execute properly (e.g. as a result of photon loss, decoherence of a quantum system 12 or other glitch), future operations may require modification to compensate for such failures;
there may be two or more different options for creating required entanglement (e.g. a choice between direct entanglement and entanglement swapping and/or a choice among two or more possible entanglement swapping chains) and the option to be used may not be determined until later;
some scheduled operations may be cancelled (e.g. to permit execution of another operation that has a higher priority);
the assignment of particular quantum information to specific individual quantum systems 12 may be determined after program 24 is created and/or may be changed depending on the availability of quantum systems 12 to store that quantum information at specific execution stages.

### Entanglement Inventory

In some embodiments entanglement scheduler 22 attempts to create additional entangled pairs of quantum systems 12 that may or may not be required to execute the operations of future execution stages 28. One or more approaches to creating such additional entangled pairs of quantum systems 12 may be performed. Some examples include;
building and maintaining an inventory of entangled pairs of quantum systems 12. For example, in a case where the quantum systems of a network 10 are assigned to different units (which, in general may be called “nodes”) entanglement scheduler 22 may be configured to create entanglement between quantum systems 12 located in different ones of the r nodes.
creating redundant entangled pairs. For example, where an operation included in a future execution stage 28 requires entanglement between a particular pair of nodes, if sufficient resources are available, entanglement scheduler 22 may automatically attempt to create two or more entangled pairs of quantum systems 12 that are each consumable to support the operation. Depending on the topology of network 10 and the locations of the nodes in network 10 creating each of the entangled pairs of quantum systems 12 may comprise directly entangling one or more pairs of the quantum systems 12 and/or creating entanglement of one or more chains of quantum systems 12 and performing entanglement swapping to entangle one or more pairs of quantum systems. Creating redundant pairs of entangled quantum systems 12 may permit the operation to be re-tried quickly if a first attempt to perform the operation is not successful for any reason and/or may improve the probability of creating the entanglement sooner. Any of the redundant pairs of entangled quantum systems 12 that are not used may be kept in inventory for possible future use.
creating entanglement to support operations that might be but will not necessarily be required in the future (e.g. operations that may be conditionally executed or needed as a result of the uncertainties described above).

In some embodiments entanglement scheduler 22 is configured to maintain an inventory of entangled quantum systems. The inventory may include:
entanglement that was created to support a particular operation but is no longer required (e.g. because the operation was cancelled or alternative entanglement was used to support the operation); and/or
entanglement that was not created to support any particular operation.

Entanglement scheduler 22 may be configured to use entanglement from the inventory to support operations instead of or in addition to generating entanglement to support the operations. Entanglement scheduler 22 may be configured to track the fidelity of entanglement in the inventory. In some embodiments, entanglement scheduler 22 may be configured to attempt to maintain a target for inventory of entanglement between specified nodes of a network. The target for entanglement between one or more pairs of nodes of the network may be varied dynamically as execution of a program proceeds. The target may be based upon anticipated requirements for entanglement to complete execution of different parts of the program.

Entanglement from the inventory may be used directly or as part of an entanglement swap chain to support an operation. In some embodiment, entanglement scheduler 22 performs entanglement distillation to improve fidelity of entanglement in the inventory.

In some embodiments entanglement scheduler 22 is configured to attempt to maintain target levels of entanglement in the inventory. For example a target may be to maintain available in inventory some number of entangled pairs of a quantum system 12 in a first node and a quantum system 12 in a second node for one or more pairs of nodes. In some embodiments different targets are specified for different pairs of nodes. In some embodiments the targets are varied dynamically such that if at any given time the operations being executed require entanglement between specific parts of the network the inventory includes more entanglement between those parts of the network.

To build and/or maintain an inventory of entangled quantum systems entanglement scheduler 22 may, for example, be configured to when it has unallocated capacity for creating entanglements of quantum systems and there are available hardware resources to create such entanglements:
attempt to maintain specified numbers of entangled pairs of quantum systems 25 between specified pairs of the nodes; and/or
identify pairs of quantum systems that are available for entanglement (e.g. not assigned for some other purpose) and attempt to create entanglement of some or all of those pairs of quantum systems.

In some embodiments where entanglement scheduler 22 identifies plural pairs of quantum systems 12 available for entanglement, entanglement scheduler is configured to prioritize some pairs over others. For example, entanglement scheduler 22 may prioritize creating entanglement of pairs of quantum systems that are: associated with nodes for which entanglement is more likely to be required (e.g. based on historical statistics for execution of a program 24, analysis of a program 24, and/or the topology of network 10 etc.); located away from other quantum systems that are holding quantum information that could be degraded by attempts to entangle the pair of quantum systems, have been identified as a pair for which high fidelity entanglement is likely to be achieved, would provide redundancy to back up another entangled pair, and/or other factors.

In some embodiments entanglement scheduler 22 analyzes a program 24 to identify the frequency with which operations for implementing the program 24 are likely to require entanglement of quantum systems in specific parts of a network 10. For example, a particular program 24 may involve multiple operations that each require entanglement between a quantum system 12 in one node and a quantum system 12 in another node. Entanglement scheduler 22 may assign a higher priority to including in an inventory of entanglement pairs of quantum systems that are respectively associated with these nodes and a lower priority to creating entanglement of pairs of quantum systems that are respectively located in nodes for which entanglement is anticipated to be required with less frequently in the execution of program 24.

In some embodiments whenever entanglement scheduler 22 has capacity to perform more entanglement attempts than are required to satisfy the needs of upcoming operations, entanglement scheduler 22 may use the excess capacity to add to an inventory of entangled pairs or other groups of quantum systems 12, prioritizing creating entanglement that is statistically most likely to be required by the program 24 and/or entanglement that has a highest score based on a combination of: the statistical likelihood that the program 24 will require the entanglement; and the criticality of the entanglement if it is required.

### Example Data

Ideally, when each execution stage 28 is reached entanglement scheduler 22 will have created entanglement that is or may be assigned to be consumed by each operation associated with the execution stage 28 that requires entanglement. Entanglement scheduler 22 may assign to any particular operation entanglement of a pair or group of entangled quantum systems 12 that was created in anticipation of serving that specific operation or that is available because it was created in anticipation of serving a different operation or created as part of an inventory of entanglement.

### Quantum System Status Data

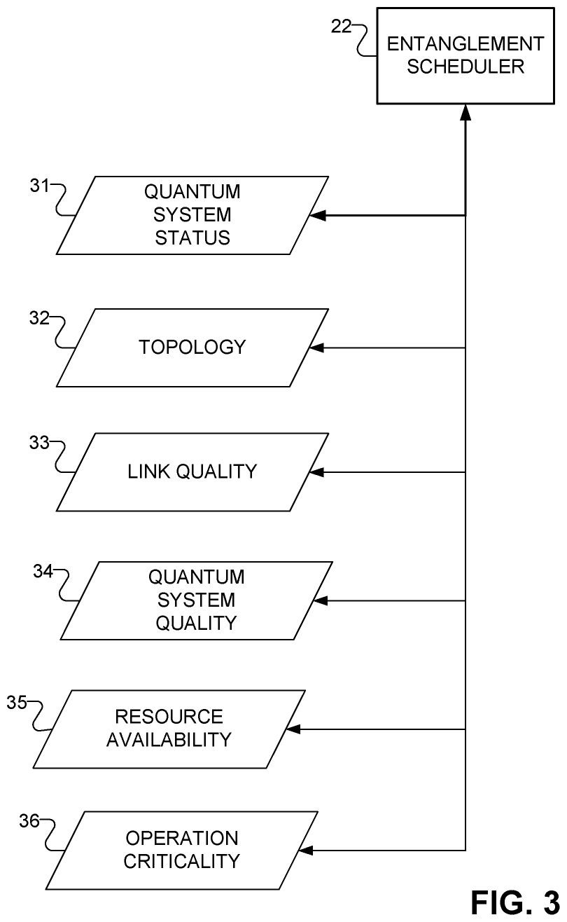

FIG. 3 shows that entanglement scheduler 22 may maintain and/or have access to various sets of information (“data stores”). These include a quantum system status data store 31 that contains information regarding the status of quantum systems 12 in network 10. Data store 31 may, for example, indicate for each quantum system 12 in network 10 whether that quantum system 12 is available (not currently allocated to program 24 and not currently entangled), entangled with one or more specific other quantum systems 12 or allocated to program 24 (e.g. to store quantum information, serve as a broker quantum system, etc.).

Quantum system status data store 31 may include information regarding when each entangled state was created and/or other information from which a current fidelity of an entangled state may be deduced and/or an estimate of the current fidelity of the entangled state. Given that over time an entangled state may decohere as a result of the passage of time and/or optical cycles/interactions that affect one or more quantum systems of the entangled state, entanglement scheduler 22 may use information about the ageing of the entangled state (e.g., time since entangled state was generated) and/or the exposure of the quantum systems of the entangled state to optical or other interactions to estimate the fidelity of an entangled state. Entanglement scheduler 22 may use the estimated fidelity to determine whether the entangled state has a high enough fidelity to support an operation. Different operations may require different levels of entanglement fidelity.

In some embodiments, entanglement scheduler 22 tracks operations such as one or more of optical cycling, resetting, measurements, application of gates etc. performed on other quantum systems that are close to a quantum system of an entangled state and is configured to estimate the fidelity of the entangled state based on estimated effects of such operations. The estimation of fidelity need not be exact. In some embodiments, each of one or more types of operations that may be applied to quantum systems neighbouring a quantum system of an entangled state is assumed to reduce fidelity of the entangled state by a predetermined factor.

In some embodiments, entanglement scheduler 22 may selectively apply “older” (possibly lower fidelity) entangled states and/or entangled states that have been exposed to more optical cycling or other interactions (possibly lower fidelity) to support less critical operations while applying entangled states that are newer and/or exposed to less optical cycling or other interactions (presumably higher fidelity) to support more critical operations. In some embodiments where entanglement scheduler maintains an inventory of entangled quantum systems 12 a pair of entangled quantum systems 12 is removed from the inventory when an estimated fidelity of the entanglement of the pair of entangled quantum systems falls below a threshold and/or when more than a specified time has elapsed since the pair of quantum systems were entangled.

### Topology Data

Entanglement scheduler 22 may maintain and/or have access to a topology data store 32 that contains information defining the topology of network 10. The topology may, for example be defined by an entanglement graph (which may also be called a “connectivity graph”) in which vertices represent nodes which each include one or more quantum systems 12 and some pairs of the vertices are connected by edges. Each edge represents the possibility of directly entangling quantum systems of nodes that correspond to the vertices connected by the edge. For example, vertices corresponding to two nodes that are optically connected or connectable to the same BSA may be joined by an edge.

In some embodiments there may be two or more hardware paths that correspond to any edge in an entanglement graph. For example, there may be two or more different BSAs that may be used to directly entangle the same two quantum systems (or different pairs of quantum systems from the same set of nodes) depending for example on the configuration of optical switches that are included in the network. Entanglement scheduler 22 may be configured to identify and select the hardware paths to use for particular entanglement attempts. Appropriate selection of hardware paths may reduce or avoid conflicts between different entanglement attempts.

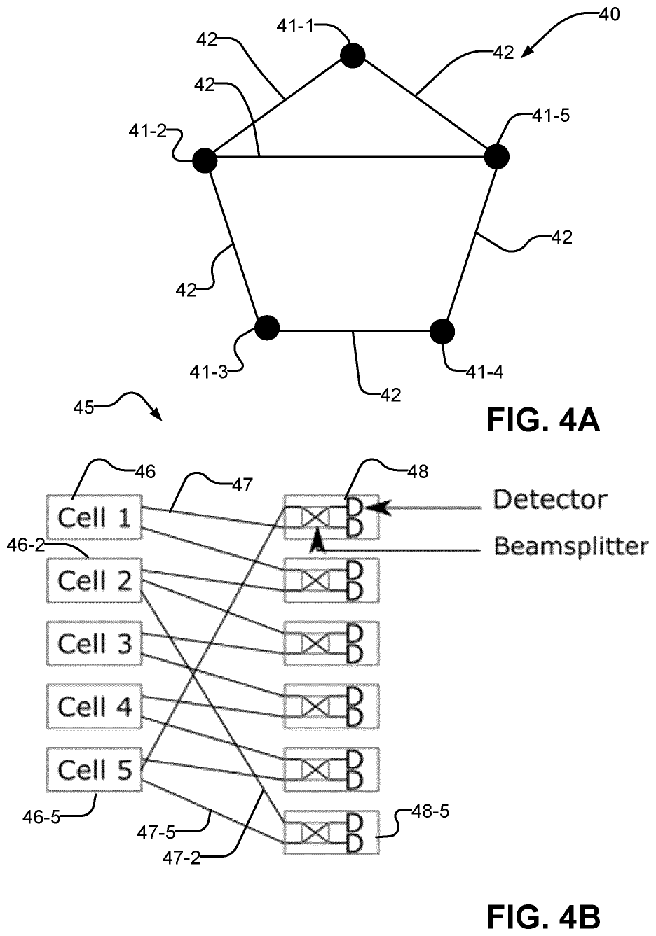

FIG. 4A shows a very simple example entanglement graph 40 that comprises a number of vertices 41 and a number of edges 42. FIG. 4B illustrates one example of hardware 45 arranged to have a topology according to entanglement graph 40. In hardware 45 each node 46 corresponds to a vertex 41 of entanglement graph 40 and each BSA 48 and associated optical connections 47 correspond to one edge of graph 40. For example, BSA 48-5 is connected to nodes 46-2 and 46-5 respectively by optical links 47-2 and 47-5. Therefore nodes BSA 48-5 and links 48-2 and 48-5 correspond to an edge in an entanglement graph which joins vertices corresponding to nodes 46-2 and 46-5. Other examples of hardware that has topology according to entanglement graph 40 include optical switches that are configurable to selectively optically connect one of one or more BSAs 48 between two nodes 46 in a way that corresponds to one edge of graph 40.

Topology data store may, for example include a data structure that indicates a plurality of nodes in the network 10, which quantum systems 12 are associated with each of the nodes, whether or not each quantum system 12 is “exposed” by the node (e.g. whether or not the quantum system 12 can be directly entangled with a quantum system 12 of some other node).

Entanglement scheduler 22 may use topology data store 32 to determine what quantum systems 22 may be entangled to support any particular operation. Depending on the topology of network 10, the entanglement required by some operations might be provided by entangling any of a plurality of pairs of quantum systems 12. For example suppose that first and second nodes each include several quantum systems, then entanglement of any available one of the quantum systems of the first node with any available one of the quantum systems of the second node may be consumed to teleport quantum information that is stored in a quantum system 12 of the first node to a quantum system 12 of the second node.

### Link Quality Data

Entanglement scheduler 22 may maintain and/or have access to a link quality data store 33 that contains information regarding the quality of links in network 10. Link quality data store may, for example, include information regarding: lossiness of links (e.g. optical connections) that may be applied to directly entangle pairs of quantum systems 12 in network 10. Information from data store 33 and/or data store 34 may be used by entanglement scheduler 22, for example, to predict how many entanglement attempts will likely be needed in order to achieve entanglement of two quantum systems 12 by way of the link.

In some embodiments link quality data store 33 is updated in real time or periodically based on statistics for entanglement attempts and/or measurements made using the links (e.g. optical connections) of a network 10.

### Quantum System Quality Data

Entanglement scheduler 22 may maintain and/or have access to a quantum system quality data store 34. Component availability data store 34 includes information regarding quantum systems 12. The information may include, for example, (de) coherence times, fidelity of one- and local two-qubit gates, levels of isolation from other quantum systems etc. These factors may affect the fidelity of quantum information stored in the quantum systems.

### Component Availability Data

Entanglement scheduler 22 may maintain and/or have access to a component availability data store 35. Component availability data store 35 may indicate times when components such as individual optical links, BSAs, switches, photon detectors etc. that may be used to create entanglement under the control of entanglement scheduler 22 are not available to entanglement scheduler 22, for example because those components have been allocated to obtain certain measurements at the reserved times. As another example, an entanglement attempt which attempts to entangle a particular pair of quantum systems 12 may utilize components such as physical optical paths that carry photons from the quantum systems 12 to detectors, as well as the detectors, switches, and the pair of quantum systems themselves. When these resources are configured for use in an entanglement attempt, other entanglement attempts that require access to some or all of these resources will be blocked. Entanglement scheduler 22 may use information from component availability data store 35, for example, to identify opportunities to create entanglement using the components at times when the components are available (not allocated for other purposes) and/or to avoid conflicts between different entanglement attempts that require use of the same resources by performing potentially conflicting entanglement attempts at different times.

For example, component availability data store 35 may store information regarding the current configuration of optical switches in network 10. Entanglement scheduler 22 may, for example, determine that an optical switch is available for use in a particular entanglement attempt if, the current configuration of the optical switch provides one or more optical paths that could be used in performing the entanglement request and those optical paths are not allocated to some other purpose that would conflict with the entanglement attempt.

In some embodiments an optical switching network comprises a plurality of switches that each have a plurality of settings. Component availability data store may include a data structure which contains data that indicates for different possible combinations of switch positions optical paths that are blocked or available. The component availability data store may indicate whether settings of individual switches are locked (i.e. the switch setting has been set for a reason that requires that the setting of the switch not be changed) or whether the setting of the switch may be changed.

Entanglement scheduler 22 may assess whether a particular entanglement attempt may be performed at a particular time by checking settings of the relevant switches and availability of other hardware that may be required for the entanglement attempt for the relevant time in the component availability data structure. If the settings of the relevant switches allow the particular entanglement or if the settings of the relevant switches are free to be changed then the particular entanglement may be scheduled. Otherwise entanglement scheduler 22 may check to see if there is an alternative time when the particular entanglement may be performed and/or schedule another entanglement attempt that is compatible with the switch settings.

### Operation Criticality Data

Entanglement scheduler 22 may maintain and/or have access to an operation criticality data store 36 that contains information regarding how critical any particular operation and/or how critical any particular entanglement is to the successful completion of program 24. Data store 36 may associate an operation and/or an entanglement used to support an operation with a low level of criticality if, for example, failure of the operation or associated entanglement could be corrected by error correction included in program 24 and/or could be detected and compensated for by adding or modifying one or more subsequent operations (e.g., adding remedial operations that do not change the evolution of the quantum circuit).

As another example, data store 36 may associate an operation or associated entanglement with a low level of criticality if the operation involves configuring a quantum system 12 to store error correction information in a case where sufficient error correction has already been stored (e.g. quantum system 12 is one of several quantum systems 12 that all store error correction information and correction of errors can be achieved with the stored information from fewer than all of the several quantum systems 12). On the other hand data store 36 may associate an operation or associated entanglement with a high degree of criticality if failure of the operation or associated entanglement would require repeating a large sequence of operations or is likely to introduce significant error in the results generated by program 24. For example, entanglement requests close to the end of a large magic state distillation protocol may be assigned a high criticality since an error at that point in the magic state distillation protocol would be likely to introduce a logical error that cannot be corrected without repeating the magic state distillation protocol.

In some embodiments, data store 36 indicates a level of entanglement fidelity (e.g., how important is it that the entangled quantum state of a pair of quantum systems 12 be very close to a maximally entangled state, such as a Bell state, for a particular operation).

Entanglement scheduler 22 may use the information in operation criticality data store 36 to make decisions such as:
whether to create redundant sets of entangled quantum systems 12 to support the operation;
whether to create entanglement of quantum systems 12 to support an operation in a way that results in a high fidelity of the entangled state e.g. by direct entanglement of the quantum systems (if possible) or by creating plural pairs of entangled quantum systems and performing entanglement purification or entanglement distillation which consumes some of the entangled pairs to achieve an entangled state that has increased fidelity.

In some embodiments some or all of the information in operation criticality data store 36 is produced by a compiler which takes as input a quantum processing algorithm (e.g. program 24) and based on the input algorithm generates a schedule 27 of operations to be applied to implement the algorithm. The quantum processing algorithm may, for example, be provided in the form of information that specifies a quantum circuit. The compiler may, for example, map logical qubits used in the processing algorithm to virtual qubits. The mapping of logical qubits to virtual qubits is one to one in some embodiments. In some embodiments some or all of the logical qubits are each mapped to a group of two or more virtual qubits. Each virtual qubit may be mapped to one or more physical quantum systems 12. The compiler may determine an optimum order of operations to be applied to implement the quantum processing algorithm, allocate qubits for use in error correction and/or as ancilla qubits (and specify operations to be performed on those qubits and/or assign levels of criticality to individual operations).

In some embodiments the compiler outputs (e.g. stores in operation criticality data store 36) information that specifies criticality levels for different operations or entanglements. In some embodiments the compiler outputs (e.g. stores in operation criticality data store 35) information that specifies required and/or desired fidelity levels for entanglements that are to be applied to implement the quantum processing algorithm.

Those skilled in the art will understand that the allocation of data among data stores 31 to 36 is illustrative only and that the same data may be arranged in many different ways, for example in a single data store, an arrangement of two or more data stores etc. Data store(s) may be implemented using any suitable available technology such as database(s), lookup tables, data structures in dynamic or static memory etc. Also not all items of data described with respect to data stores 31 to 36 are required in all embodiments.

### Mapping Programs to Hardware

Entanglement scheduler 22 operates to schedule entanglement of physical quantum systems 12. To execute a particular program 24 there is a need to assign virtual qubits (and/or qudits in some cases) that are provided by program 24 to quantum systems 12. For example virtual qubits referenced in the output of a compiler as described elsewhere herein may be mapped to specific quantum systems 12 of a network 10.

Performance of a particular program 24 may be improved by mapping the virtual qubits to physical qubits in such a way that, where the program 24 calls for two virtual qubits to be entangled, those virtual qubits are mapped to quantum systems 12 that can be entangled directly (without entanglement swapping) or with entanglement swapping involving short entanglement chains.

Entanglement scheduler 22 may be configured to process a program 24 to identify entanglement required by the program 24 and to optimize a mapping of virtual qubits specified by the program 24 to quantum systems 12. The mapping may, for example, be optimized so that the pairs of the quantum systems 12 that will be entangled support operations of program 24 are, where possible: in the same node; or respectively in nodes that correspond to vertices that are joined by an edge of an entanglement graph for the network 10; or for which there is an entanglement mechanism operable to entangle the quantum systems efficiently (e.g. low-loss optical connections to a BSA).

In some embodiments the mapping is based in part on performance metrics of individual physical qubits. These performance metrics could include single qubit control fidelity, optical properties, or decoherence times of quantum systems 12. For example, virtual qubits that have a high criticality or will be used to hold quantum information over longer periods may be mapped to quantum system 12 that have longer decoherence times than other ones of quantum systems 12.

It is not required that the mapping remain fixed throughout execution of a program 24. Entanglement scheduler 22 may dynamically change the mapping as execution of the program 24 proceeds. This may be advantageous for example, if a branch of the program 24 or a later part of the program 24 could benefit from a different mapping of virtual qubits to quantum systems 12 (e.g., the entanglement scheduler may identify, within an instruction cycle, one or more pairs of virtual qubits that will be frequently entangled. In response, the entanglement scheduler may dynamically change the mapping of virtual qubits to quantum systems so that the quantum systems to which the identified pair(s) of virtual qubits are mapped are selected to have better connectivity to the same detector unit. For example, the mapping may be changed so that the pair of virtual qubits are mapped to quantum systems that may be connected to the same detector unit via one or more low-loss channels).

To implement remapping, entanglement scheduler 22 may, for example, teleport the state of one qubit into the state of another available (“empty”) qubit, and/or swap the quantum states of one or more pairs of qubits. Any entanglements required to implement the operations required to facilitate remapping of virtual qubits to quantum systems 12 may be scheduled by entanglement scheduler 22 as described herein. Since remapping typically requires incurring a cost of using entangled states, entanglement scheduler 22 may determine whether or not to proceed with a particular dynamic remapping by balancing the potential benefit of remapping against the cost of remapping.

### Topology of the Network

In some embodiments the topology of network 10 may correspond to a non-planar graph. In some embodiments the topology of network 10 corresponds to all or a portion of a regular entanglement graph that is not all-to-all connected. In some embodiments the entanglement graph is a strictly regular graph. In some embodiments the entanglement graph is a distance regular graph. In some embodiments the entanglement graph is the result of deleting some vertices and deleting edges that terminate at those deleted vertices from a distance regular graph or a strictly regular graph. The entanglement graph may be selected to have a desired number of vertices for an intended application and to have edges which connect the vertices in a way that achieves a desired balance between factors that include: saving cost, reducing switching hardware complexity, reducing photon loss in the network, and maintaining sufficiently high fidelity of entanglement.

The choice of entanglement graph can affect parameters such as the number of BSAs and/or the type of optical switches that may be used to efficiently implement the graph; the maximum number of entanglement swaps sufficient to entangle quantum systems associated with any two vertices of the graph; and the number of entanglement attempts that can be performed in parallel. Cost, physical size and complexity of network hardware may be optimized for a required performance level by selecting a topology for network 10 that corresponds to an entanglement graph that has a structure and number of edges optimized to achieve a desired balance of some or all of these factors.

The configuration of nodes of the network may also affect performance of a quantum network. Quantum networks as described herein may be implemented using nodes that provide two or more “layers” of quantum systems. Quantum systems in a computational layer or “alpha” layer may be used to perform quantum computations and to store quantum information. Quantum systems belonging to the alpha layer may be internal to each node and isolated from direct interaction with quantum systems of other nodes. Quantum systems of one or more higher level layers may be used to establish entanglement between quantum systems of different nodes, purify or distill entanglement etc. Entanglement of higher level quantum systems in different nodes may be transferred to alpha quantum systems and then consumed to teleport quantum information among nodes, to provide teleported 2 qubit gates where the two qubits are provided by quantum systems in different nodes, perform calculations, and process information, etc. In some embodiments, quantum systems in one layer may serve as brokers for quantum systems in another layer that serve as clients.

Some layered embodiments include three or more layers of quantum systems. Quantum systems of an intermediate layer may help to isolate quantum systems of the alpha layer from external influences.

Quantum systems of the intermediate layer may be used to enhance fidelity of entanglement (e.g. by entanglement distillation). For example, in some embodiments some or all quantum systems in a higher level layer are connected to BSAs by optical links that are relatively low quality (e.g. because the optical links may extend over relatively long distances). If a particular operation requires entanglement between two nodes that has higher fidelity than would result from directly entangling two of the higher level quantum systems, with one of the higher level quantum systems in each of the nodes, one could entangle one or more such pairs of higher level quantum systems multiple times and transfer each resulting entanglement to a pair of the intermediate level quantum systems to yield a desired number of pairs of entangled intermediate level quantum systems. Entanglement distillation may then be performed on the entangled pairs of intermediate level quantum systems to yield a reduced number (which could be one) of entangled pairs of the intermediate level quantum systems for which the entanglement is higher fidelity than the original entanglement of each pair of higher level quantum systems. For example, an entanglement distillation protocol may involve the steps in the following Table 1.

TABLE 1
Example entanglement distillation protocol

| Step | Description |
|---|---|
| 1 | Entangle electron spins (e.g. of two structures such as T centres). |
| 2 | Transfer the entanglement to other spins of the structures (e.g. |
| | nuclear spins). This may be done, for example using deterministic |
| | SWAP gates. |
| 3 | Entangle the electron spins again. |
| 4 | Do distillation between entangled electron spins and entangled |
| | nuclear spins to enhance fidelity of entanglement of nuclear |
| | spins. |
| 5 | repeat 4 and 4 as desired until the other (e.g. nuclear) spins |
| | have a desired fidelity of entanglement. |

In some embodiments some or all of the alpha quantum systems and/or some or all of the intermediate level quantum systems and/or some or all of the higher level quantum systems, if present, are provided by an intrinsic spin of a T centre which includes an electron qubit and at least one nuclear spin qubit. In some embodiments some or all of the alpha quantum systems and/or some or all of the intermediate level quantum systems and/or some or all of the higher level quantum systems, if present, are provided by an intrinsic spin of an NV centre which includes one or more carbon spin qubits and an electron spin qubit. For example, the carbon nuclear spin qubit(s) may serve as alpha qubit(s) and the electron spin may serve as an intermediate level or higher level qubit.

Providing such a layered architecture can be beneficial since it allows entanglement to be provided between alpha quantum systems while reducing the number of times the alpha quantum systems are involved in entanglement attempts. This helps to maintain fidelity of quantum information being stored in nuclear spins of the alpha quantum systems. Furthermore, by creating plural pairs of entangled quantum systems (e.g. using quantum systems of an intermediate beta layer) and performing entanglement distillation one can create high fidelity entangled states that can facilitate achieving high fidelity computational states (e.g. by accurately teleporting a computational state from one quantum system 12 of a network 10 to another quantum system of the network 10). Entanglement scheduler 22 may manage entanglement attempts to achieve the potentially large number of entangled quantum systems that may be applied for executing a program 24.

### Prioritizing Entanglement Attempts

At any given time the number of entanglement attempts that entanglement scheduler 22 can perform may be limited. Entanglement scheduler 22 may assign weights to different entanglement attempts that may be initiated in upcoming entanglement generation stages 29. Weights may be assigned dynamically.

Weights may be applied to prioritize entanglement attempts to increase the likelihood that entanglement required for particular upcoming operations will be available when the operations are scheduled to be executed. The weights may be dynamically increased if the required entanglement has not been created as the time for which the operation is scheduled becomes closer. In some embodiments, when the dynamically assigned weight exceeds a threshold, parallel attempts to create the entanglement required by the upcoming operation may be initiated or increased (for example, an operation may require entanglement of a quantum system of a first node and a quantum system of a second node. Each of the first and second nodes may include two or more quantum systems such that there are several pairs of quantum systems that could provide the required entanglement).

In some embodiments, entanglement scheduler 22 is configured to cancel one or more scheduled entanglement attempts that are blocked by a hardware conflict with other entanglement attempts that have greater weights. In some embodiments entanglement scheduler 22 is configured to reschedule the cancelled entanglement attempts. In some embodiments entanglement scheduler 22 is configured to find alternative ways to generate the entanglement that the cancelled entanglement attempts were intended to generate.

### Entanglement Options

Entanglement scheduler 22 may determine how to create entanglement between or among certain quantum systems 12. Depending on the topology of network 10 there may be various options for creating the desired entanglement to support operations for executing a program and/or teleporting quantum states among quantum systems.

For example, in some cases entanglement may be created either directly or indirectly by entanglement swapping. If entanglement swapping will or must be used to create entanglement then there may be several ways to achieve the desired entanglement by direct entanglement and/or by entanglement swapping. For example:
It may be possible to perform direct entanglement using any of a plurality of BSAs that may receive photons by way of different optical paths.
There may be plural entanglement chains that may be used to generate entanglement of a pair of quantum systems. Furthermore, there may be plural BSAs and plural optical paths that may be used for generating entanglement of pairs of quantum systems in the entanglement chain and performing Bell state measurements to implement entanglement swapping.

In some embodiments entanglement scheduler 22 identifies plural ways that may be used to achieve desired entanglement. This may be done using information from topology data store 32. For example, entanglement scheduler 32 may identify plural paths between two endpoint quantum systems 12 along which entanglement may be created and then transferred to the endpoint quantum systems 12 by entanglement swapping.

In some embodiments entanglement scheduler 22 comprises a lookup table that takes as input information identifying a pair of endpoint quantum systems 12 of a network 10 and in response, provides as output possible paths that may be used to entangle the pair of endpoint quantum systems 12. The possible paths may be determined in advance. In some embodiments the possible paths are filtered for compatibility with other entanglement attempts and/or other operations that are scheduled for the same time that entanglement attempts directed to entangling the pair of endpoints are being scheduled for.

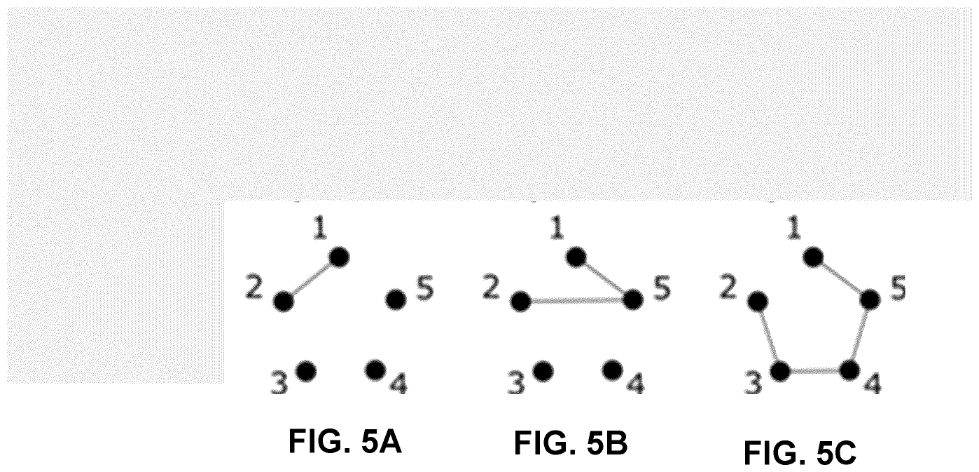

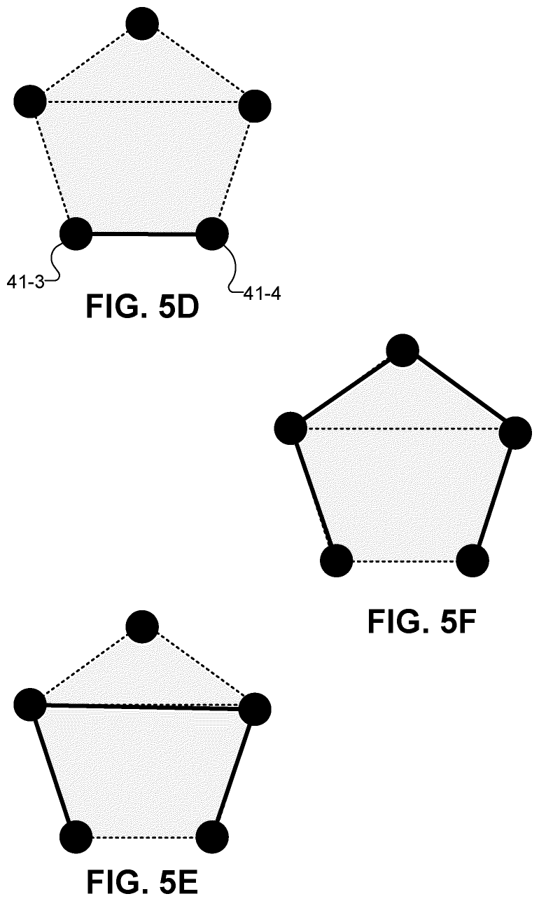

FIGS. 5A to 5C show example paths that may be used to entangle endpoint quantum systems 12 at nodes corresponding to vertices 41-1 and 41-2 of entanglement graph 40.

Entanglement scheduler 22 may determine which one(s) of the possible entanglement paths to assemble based on factors such as:
which of the possible entanglement paths are or will be available when it is desired to create the entanglement (For example if vertex 41-5 corresponds to a node that, at the applicable time, will have no quantum system 12 available to participate in entanglement swapping then the paths shown in FIGS. 5B and 5C are not available).
how long is the path (paths that require fewer entanglement swaps may be preferred over longer paths, other factors being equal).
is there already created entanglement in inventory on the path that can be used (a path may be preferred if the desired entanglement may be achieved in a reduced number of steps by starting from already existing entanglement).
in cases where entanglement scheduler 22 makes redundant entanglement attempts to increase the likelihood of successful entanglement in a given time and/or entanglement scheduler 22 is scheduling entanglement attempts to create entanglement that is not certain to be needed (e.g. the operation that the scheduled entanglement attempt will support will be executed with a probability of less than 100%), a path may be preferred if the path includes parts (edges or sequences of edges) for which entanglement on the part is in demand for some other reason. For example, if at the same time that a path for entangling endpoint quantum systems 12 at nodes corresponding to vertices 41-1 and 41-2 of entanglement graph 40 is being selected it is also known that there will be a need for entanglement of quantum systems 12 at nodes corresponding to vertices 41-2 and 41-5 then the path of FIG. 5B (which includes an edge between vertices 41-2 and 41-5) may be given increased weight so that it is more likely to be selected. For example, where entanglement scheduler 22 is working on developing paths for entangling quantum systems 12 at each of two or more sets of endpoints then paths that overlap may be preferred since any excess entanglement created in an attempt to achieve entanglement between one set of endpoints may also be used to create entanglement between the other set of endpoints.

At any given time entanglement scheduler 22 may have identified many pairs of quantum systems 12 for entanglement. These may include, for example:
pairs of quantum systems that can be directly entangled to serve a scheduled operation,
pairs of quantum systems that can be directly entangled to form part of a path on which entanglement swapping can be used to provide entanglement to support a scheduled operation,
pairs of quantum systems that can be directly entangled to be added to an inventory of entangled states,
pairs of quantum systems that can be directly entangled to form part of a path on which entanglement swapping can be used to provide entanglement to be added to an inventory of entangled states.

FIG. 11 schematically illustrates ways in which entanglement among quantum systems 12 may be achieved in a multi-layer network 10. In this example, each node includes at least one internal (“alpha”) quantum system and plural communication quantum systems. The alpha quantum system may be applied to execute a program 24 while the communication quantum systems may be applied to attempt and generate entanglement between different nodes.

In some embodiments an entanglement scheduler 22 may be responsible for creating only inter-node entanglement. In some embodiments an entanglement scheduler 22 is responsible for creating both intra node and inter node entanglement.

Often the number of entanglement attempts that can be performed during any entanglement generation stage 29 is limited by hardware constraints to a number that is smaller than the number of pairs of quantum systems 12 that are being scheduled for entanglement. In some embodiments entanglement scheduler 22 uses a weighting scheme to determine which entanglement attempts will be made in any entanglement generation stage 29. The weights assigned to each pair of quantum systems 12 being considered may be based on factors such as:
how imminent is the operation for which entanglement of the entangled pair will support (more imminent may correspond to greater weight);
how many entanglement attempts is it likely to take to achieve the entanglement—this may be determined based on the entanglement protocol to be used and the lossiness of connections to be used in the entanglement attempt (pairs of quantum systems for which more entanglement attempts are expected may be given a higher weight so that their entanglement will be prioritized to be attempted sooner);
how likely is it that the operation that the entanglement attempt is intended to support will be executed (higher probability may be given more weight);
will the entanglement attempt require use of hardware components (e.g. BSAs, optical links, switches) that are sometimes unavailable because they are allocated for other purposes (entanglement attempts that require use of hardware resources that are more likely to be unavailable for any reason may be given higher weights so that they will be given priority when the hardware resources are available or may be given lower weights so that alternative entanglement attempts that do not require use of the hardware resources will be favoured);
is the entanglement attempt required to replenish an inventory of entangled states (weight may be higher if the entanglement attempt could create an entangled state between quantum systems in nodes for which inventory is lower than a target level.
etc.

An individual entanglement attempt may have value for different reasons and each of these may contribute to the weight. For example entanglement of a particular pair of quantum systems 12 may be useful for two or more reasons such as:
the entanglement could be used to support any of one or more particular upcoming operations;
the entanglement could be used as part of one or more entanglement swapping path(s) that have value; and/or
the entanglement could be added to an entanglement inventory.

In such cases entanglement scheduler 22 may assign a weight to the entanglement attempt by combining (e.g. adding, weighted summing, etc.) weights allocated for each of two or more reasons.

In each entanglement generation stage 29, entanglement scheduler 22 may select entanglement attempts in descending weight order starting with the most highly weighted entanglement attempt until entanglement scheduler 22 has selected however many entanglement attempts the entanglement generation stage 29 can support. If a selected entanglement attempt would block execution of another lower weighted entanglement attempt (e.g. due to a hardware conflict) the lower weighted entanglement attempt may be performed in a subsequent entanglement generation stage 29. The numbers of entanglement attempts 29 that can be performed in individual entanglement generation stages 29 may vary as a result of changes in the utilization of components of the hardware of a network 10 (e.g. whether certain components are or are not available for the entanglement attempt).

At appropriate times such as: after each entanglement generation stage 29, after every N^{th} entanglement generation stage 29, or once per instruction cycle, weights of pending entanglement attempts are updated. The updating may take into account factors such as:
some of the entanglement attempts may have succeeded.
some operations may have been cancelled.
allocation of virtual qubits to quantum systems 12 may have been remapped, making some entanglement attempts no longer necessary.
some entanglement attempts are becoming more urgent.

### Example of Entanglement Scheduling

The following example assumes a network 10 that includes a number of nodes that correspond to vertices in an entanglement graph. Each of the nodes has at least one communication quantum system 12 (i.e. a quantum system 12 that can be directly entangled with a communication quantum system 12 of another node) and may additionally have one or more internal quantum systems 12.

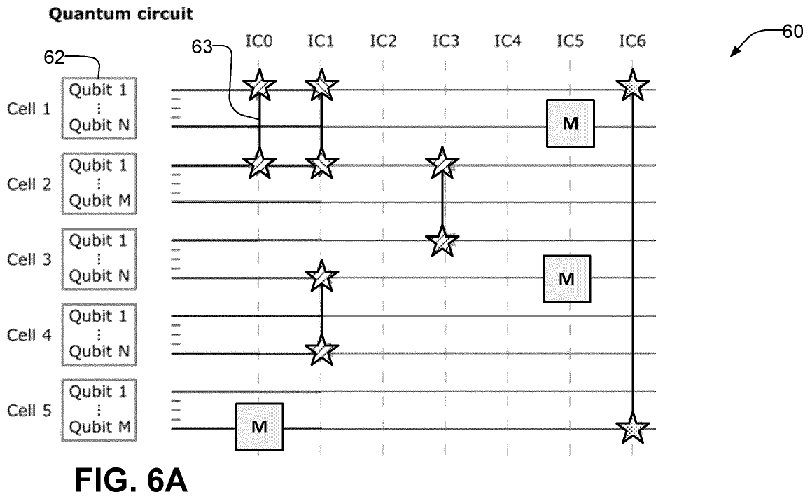

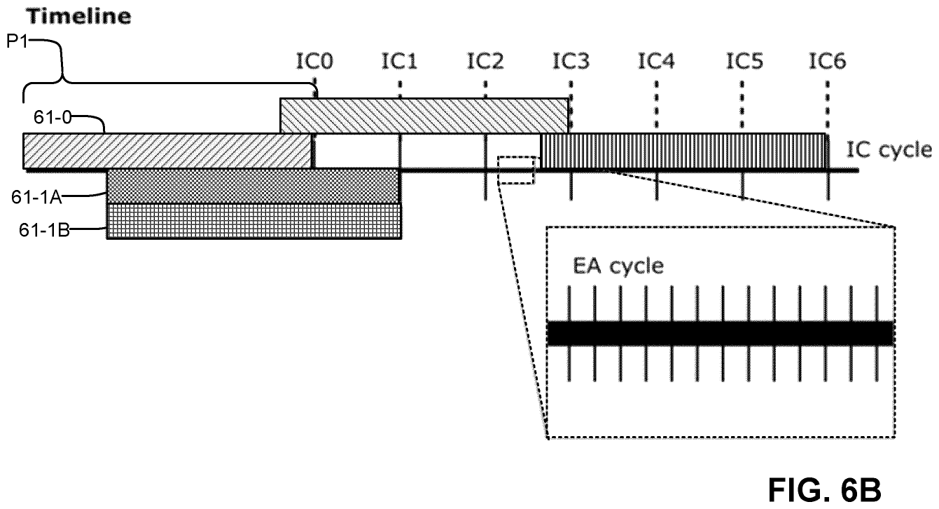

FIG. 6A shows a portion of a quantum circuit 60 in which horizontal lines represent exposed quantum systems 12 each associated with a node 62, vertical lines 63 between stars represent creation of entanglement between the quantum systems 12 corresponding to the horizontal lines on which the stars are situated, and time progresses toward the right hand side of quantum circuit 60. Measurements are indicated by the letter “M” in square boxes.

FIG. 6B shows a portion of an entanglement schedule corresponding to the quantum circuit of FIG. 6A.

Entanglement scheduler 22 uses the input circuit of FIG. 6A or another representation of a program to be performed using the quantum systems of network 10, an entanglement graph for network 10 (which in this example is provided by FIG. 4A) and a scheduling algorithm to attribute a priority rating (e.g. a weight) to all possible entanglement attempts that could be executed to support the entanglements and measurements specified by the upcoming instruction cycles within a look-forward window that includes the next N_{LW} instruction cycles. In this example N_{LW}=3.

Entanglement scheduler 22 allocates initial resources in the period P1 leading up to execution stage IC0 (which indicates the start of run-time of circuit 60). At IC0 circuit 60 contains a request for entanglement between node 1 and node 2 as well as a measurement request on qubit M of node 5.

To create the entanglement resource between node 1 and node 2, entanglement scheduler 22 may prioritize from the entanglement chain options shown in FIGS. 5A to 5C.

Since the success of any entanglement request is probabilistic as described above, entanglement scheduler 22 commences entanglement attempts in entanglement generation stages prior to IC0 so that the entanglement is ready at IC0. Any of the chains illustrated in FIGS. 5A to 5C may be consumed to accomplish the entanglement specified at IC0. Entanglement scheduler 22 may therefore identify entanglement attempts corresponding to all pairs of nodes that are part of these chains and assign a priority level to each of these potential entanglement attempts. For example, each potential entanglement attempt may be assigned a weight based on factors described elsewhere herein.

Entanglement scheduler 22 may then execute the entanglement attempts in a priority order until the desired entanglement for IC0 is provided. This is indicated by bar 61-0.

In runtime, entanglement scheduler 22:
After each execution stage, identify potential entanglement attempts that may be performed to satisfy operations specified by quantum circuit 60 within the look forward window, and create or update weights for the potential entanglement attempts;
For each entanglement generation stage, select which potential entanglement attempts to proceed with based on the hardware resource state (e.g. state of available quantum systems, switches, detectors, optical paths), and update the entanglement inventory with successful entangled pairs of quantum systems 12.

Execution stage IC1 specifies the same node 1-node 2 entanglement as IC0 as well as node 3-node 4 entanglement. Entanglement scheduler may commence entanglement attempts to create the entanglement specified for execution stage iC1 during entanglement generation stages prior to IC0 to provide the requested entanglement in time for IC1. This is indicated by bars 61-1A and 61-1B.

In preparation for execution stage IC1 entanglement scheduler 22 needs to allocate the available resources to achieve two entanglements in time for IC1. In this example, there are several ways to achieve each of the required entanglements. Any of the chains illustrated in FIGS. 5A to 5C may be consumed to accomplish the entanglement of nodes 1 and 2 specified at IC1. Any of the chains illustrated in FIGS. 5D to 5F may be used to provide the entanglement of nodes 3 and 4 specified at IC1.

As described above, each potential entanglement attempt may be assigned a priority value (e.g. weight). The weight may be based at least in part on the relative desirability of the chain(s) that entanglement created by the entanglement attempt can form a part of. The weight for a particular entanglement attempt may include a contribution from each chain that the entanglement attempt may form part of. Each contribution may, for example be based on factors such as chain length (shorter chains may be associated with greater weights than longer chains), time until the entanglement is required (weights assigned to a chain may increase as the time becomes shorter), how that chain overlaps with other possible chains (one chain might be favoured over others in the case of entanglement resource overlap) and how close is each possible chain to being completed (an entanglement attempt directed to entangling a segment of a chain may be weighted more highly as more and more other segments of the chain are already entangled). Entanglement scheduler 22 may then execute entanglement attempts in an order based on their relative weights.

In some embodiments in which a weight is assigned to a particular entanglement attempt at least in part based on whether other entanglements have been achieved (e.g. other entanglements to complete an entanglement chain have been completed) then the contribution to the weight assigned to the fact that the other entanglements have been completed may be adjusted based on the estimated fidelity of the other entanglements such that the weight contributions based on the other entanglements will decrease with the age of the other entanglements.

In this case—since both entanglements required at IC1 occur at the same execution stage, the “time until entanglement required” is the same. Therefore, everything else being equal, the shortest path in both of these cases (FIGS. 5A and 5D) will be weighted highest. However, in a different scenario in which a future entanglement request, at a later execution stage ICn, requires nodes 2 and 5 to be entangled, an additional weight factor could enhance the priority of the chains shown in FIGS. 5B and 5E.

Entanglement scheduler 22 may also account for the criticality of entanglements specified by quantum circuit 60. For example, if the impact of a missed entanglement on node 1 and 2 is not likely to result in a large error on a final result and a missed entanglement of node 3 and 4 would result in a meaningless final result then entanglement scheduler 22 may prioritize entanglement attempts that include the path shown in FIG. 5C which includes entanglement of nodes 3 and 4.

At each entanglement generation stage between execution stages IC_{X} and IC_{X+1} entanglement scheduler 22 may update the entanglement resource pool (including updating which nodes, qubits, and connectivity hardware are available for entanglement attempts and re-assigning weights to potential entanglement attempts based on which entanglement attempts have succeeded or failed since the last update. In some embodiments entanglement scheduler 22 is configured to modify upcoming operations based on which entanglement attempts succeeded or failed. For example if after N entanglement generation stages between execution stages IC0 and IC1 Node 1 and Node 2 have not been successfully entangled, then entanglement scheduler 22 may change one or more operations scheduled to be performed at one or more subsequent execution stages to accommodate the non-availability of entanglement between nodes 1 and 2 at execution stage IC1. For example all subsequent execution stages may be shifted to a later time or gates that accommodate for the error may be introduced in or changed in one or more subsequent execution stages. As another example a round or error correction may be added or performed earlier.

In some embodiments entanglement scheduler 22 tracks failed operations (e.g. which scheduled entanglements did it fail to provide). Entanglement scheduler 22 may produce a report identifying each failure. In some embodiments the report includes an estimate of the cumulative error on the result(s) yielded by the quantum circuit.

### Example Hardware Implementation

The present technology does not require that quantum systems 12 have any particular structures. Entanglement of any quantum systems 12 that may store quantum information and be manipulated to implement quantum informatics processes may be coordinated by an entanglement scheduler 22 as described herein.

One example of hardware that may be controlled by an entanglement scheduler 22 includes matter-based quantum systems that are arranged in nodes (see e.g. nodes 48 in FIG. 4B). Each node may include one or more matter-based quantum systems. Exposed quantum systems in the nodes are optically coupled to Bell state analyzers by optical connections. The optical connections may, for example, provided by optical waveguides such as optical fibers, waveguides provided by integrated photonic circuits etc.

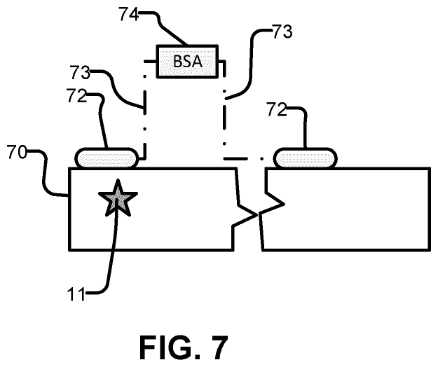

In some embodiments the quantum systems 12 are provided in or on a substrate 70 (see FIG. 7). Substrate 70 may, for example, comprise a crystalline material such as silicon, gallium arsenide, or diamond.

Quantum systems 12 may, for example, be provided by spins associated with luminescent centers in the crystalline material, quantum dots, impurities in the crystalline material or the like.

In some embodiments, quantum systems 12 comprise spins associated with T, G, I or M centers in silicon or NV centers in diamond.

In some embodiments substrate 70 is made of a material in which atoms that make up the material are substantially composed of isotopes for which nuclei have zero spin. For example, substrate 70 may comprise crystalline silicon that is isotopically enriched in ²⁸Si (e.g. is made up of 90% or more or 95% or more or 99% or more or 99.5% or more by number ²⁸Si). ²⁸Si is an isotope of silicon for which the nucleus has zero intrinsic spin. In some embodiments substrate 70 comprises a silicon on insulator (SOI) structure.

In some embodiments, quantum systems 12 are selected to have long coherence times such that when quantum states of two of the quantum systems 12 are entangled the time period during which the fidelity of the entanglement remains high enough to reliably support quantum operations is relatively long. In some embodiments entangled quantum systems 12 have decoherence times on the order of 1 millisecond or 10 milliseconds or 100 milliseconds or more.

An advantage of selecting quantum systems 12 to be provided by luminescent centers, impurities or other defects in a crystalline substrate is that some such quantum systems (including the nuclear spin states of T centers) have relatively very long decoherence times such that entanglement of such systems may be created relatively long before that entanglement will be consumed to support an operation.

Individual nodes may be formed on the same substrate 70 or different substrates 70. Optical structures may be formed on or in substrate 70. The optical structures may be configured to couple individual photons emitted from individual ones of quantum systems 12 into corresponding light guides (e.g. optical fibers). The light guides may be configured to carry the single photons to a Bell state analyzer which may be applied to facilitate entanglement of a pair of the quantum systems.

In some embodiments the optical structures comprise optical resonators 72 that are located in close proximity to corresponding quantum systems 11 and have resonant wavelengths that correspond to optical transitions of the corresponding quantum systems 11. A photon emitted when one of the quantum systems 11 undergoes a quantum transition (e.g. a spin-selective optical cycle) is coupled into the corresponding optical resonator from where it can be delivered via suitable optical connections 73 to a Bell state analyzer 74 or other photon detector. Optical resonators 72 may, for example comprise photonic cavities. Optical connections 73 may include optical switches operable to route single photons originating from a quantum system 11 to one or a plurality of Bell state analyzers 74 or other photon detectors.

The optical connections between quantum systems 12 of different nodes and Bell state analyzers define the topology of a network 10 that may be represented by an entanglement graph. Each node may include optical or other coupling between quantum systems of the node.

### Example Method

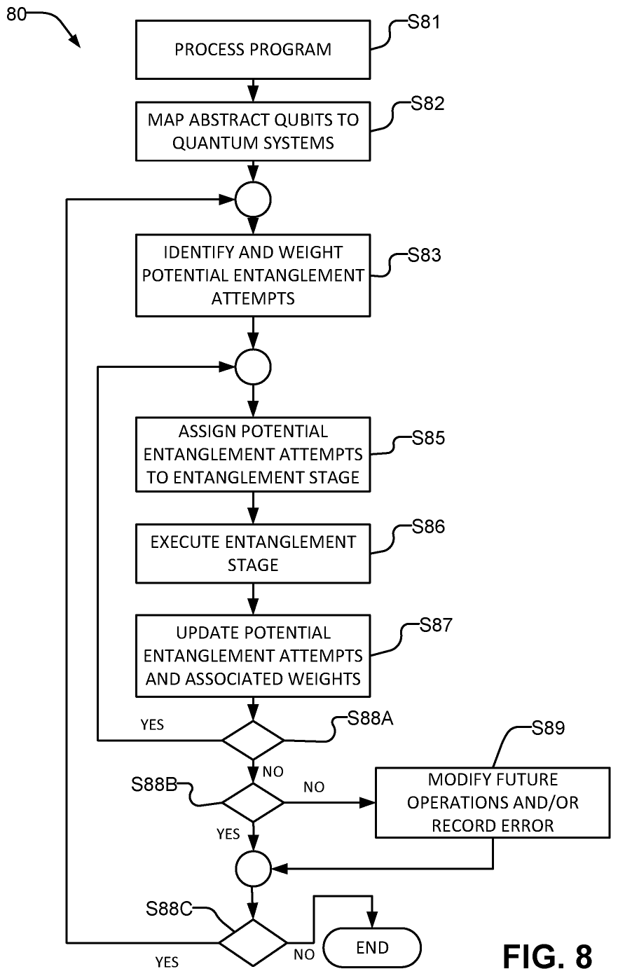

FIG. 8 is a flowchart that illustrates an example method 80 that may be performed by a control system for a network to implement entanglement scheduling. At block S81 a program 24 is processed. The processing may identify operations that require entanglement and the virtual qubits that should provide the entanglement.

Block S82 maps the virtual qubits to quantum systems of a network based at least in part on the output of block S81.

Block S83 identifies potential entanglement attempts that could be made to achieve entanglement identified in block S81 and/or add to an entanglement inventory. Block S83 may identify entanglement that may be needed in a current look forward window covering one or more future execution stages.

Block S83 also applies priority values such as weights to the entanglement attempts identified in block S83.

Block S85 identifies one or more of the potential entanglement attempts to be started in the current entanglement generation stage based at least in part on the priority values determined in block S83. In some embodiments block S85 also considers whether any hardware resources needed to perform the potential entanglement attempts are available. Potential entanglement attempts for which all required hardware resources are not available may be deferred to a later entanglement generation stage 29 when the required hardware resources may be available.

Block S86 executes the entanglement attempt(s) of the current entanglement generation stage (e.g. by performing the one or more potential entanglement attempts identified at block S85).

Block S87 updates the potential entanglement attempts and priority values based at least in part on results of the entanglement attempt(s) executed in block S86. In some embodiments block S87 is performed only once per instruction cycle (e.g. during an execution cycle). In some embodiments block S87 is performed after every entanglement generation stage 29. In some embodiments block S87 is performed less frequently than once every entanglement generation stage but more frequently than once for every instruction cycle.

Block S88A determines whether there are more entanglement generation stages before the next execution stage. If YES method 80 continues at block S85. If NO method 80 continues to block S88B.

Block S88B determines whether the entanglement to be consumed by an upcoming execution stage has been created. If YES, Block S88B continues to block S88C. If NO, block S88B continues method 80 at block S89 which does one or both of delaying or modifying operations or adding operations to one or more future execution stages to compensate for the failure to create the entanglement on time for an upcoming execution stage. After block S89 method 80 continues to block S88C. Block S88B is not necessarily performed after every entanglement generation stage 29. In some embodiments block S88B is performed once per instruction cycle or less frequently than once every entanglement generation stage but more frequently than once for every instruction cycle.

Block S88C determines whether a new look ahead window requires analysis. If YES method 80 continues at block S83 to process the new look ahead window. If NO, method 80 ends.

### Example

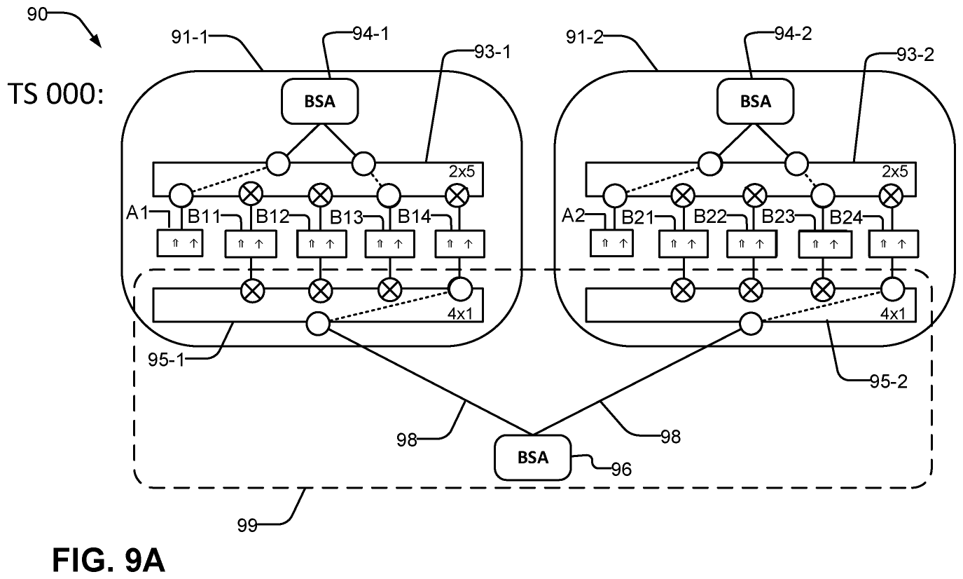

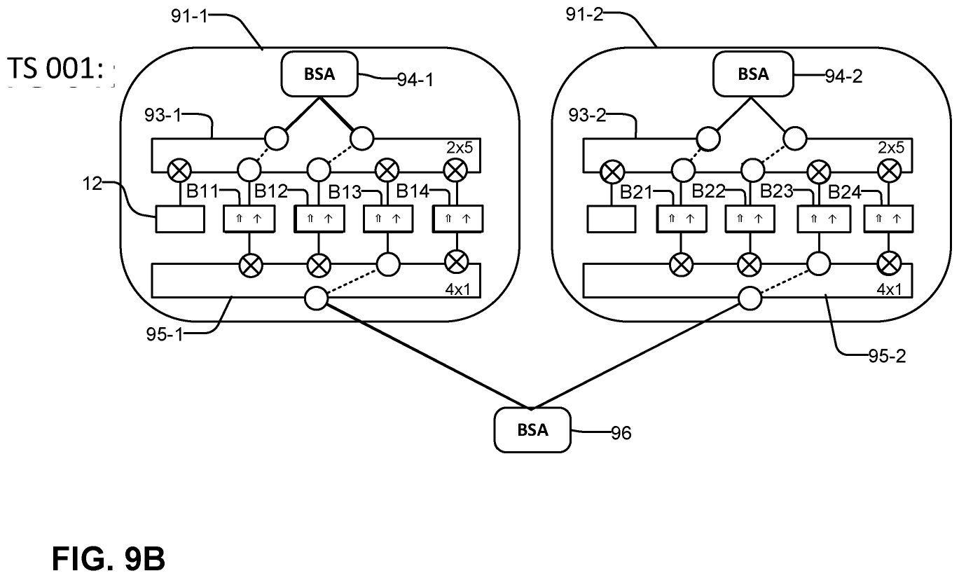

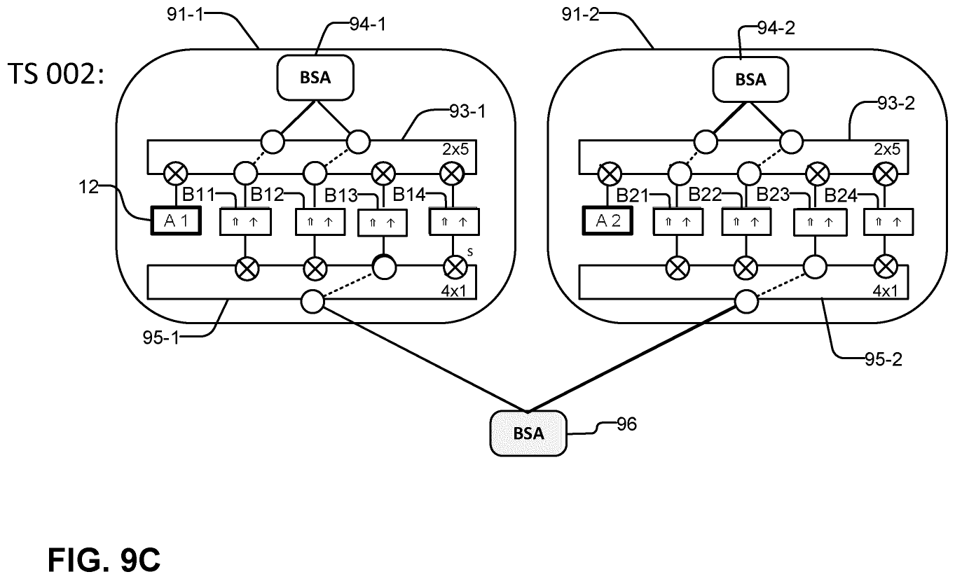

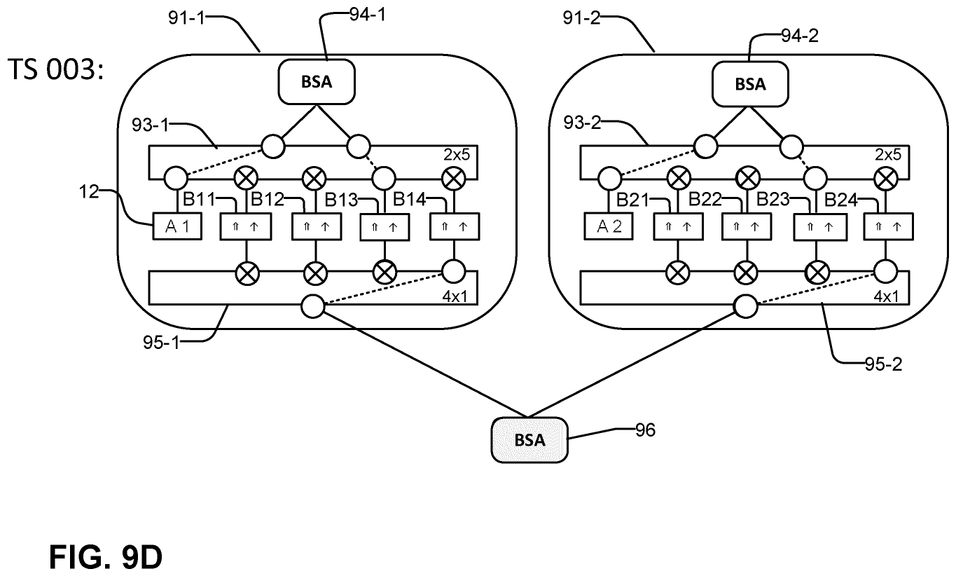

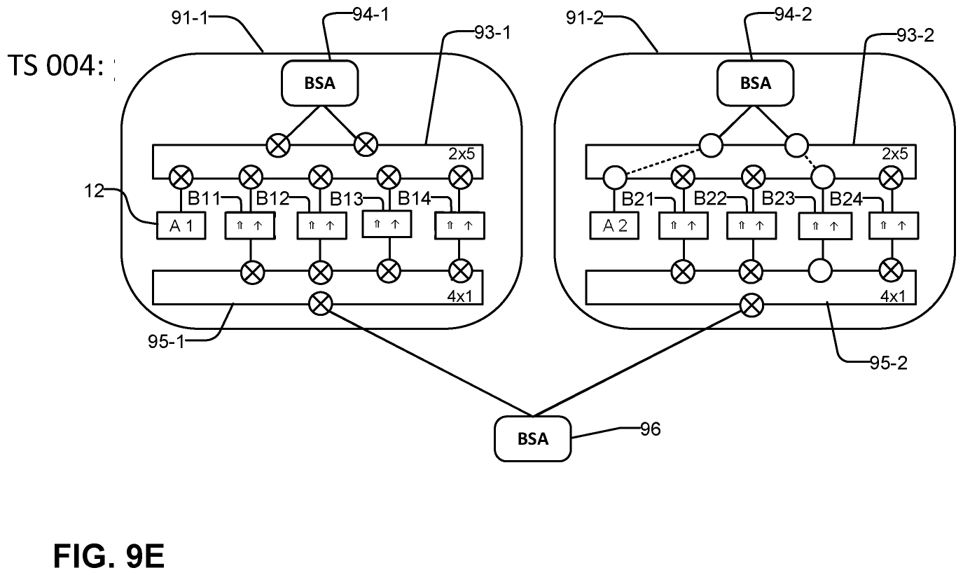

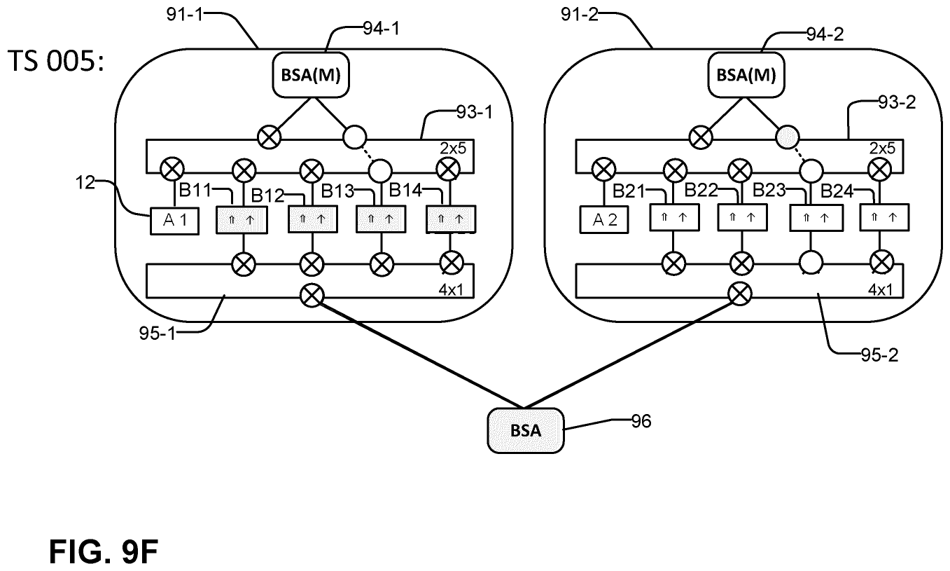

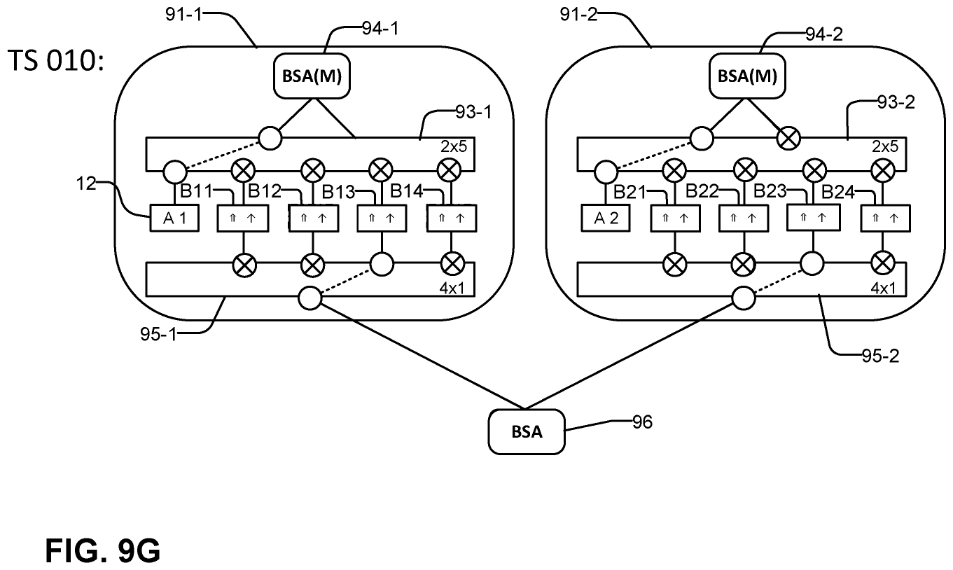

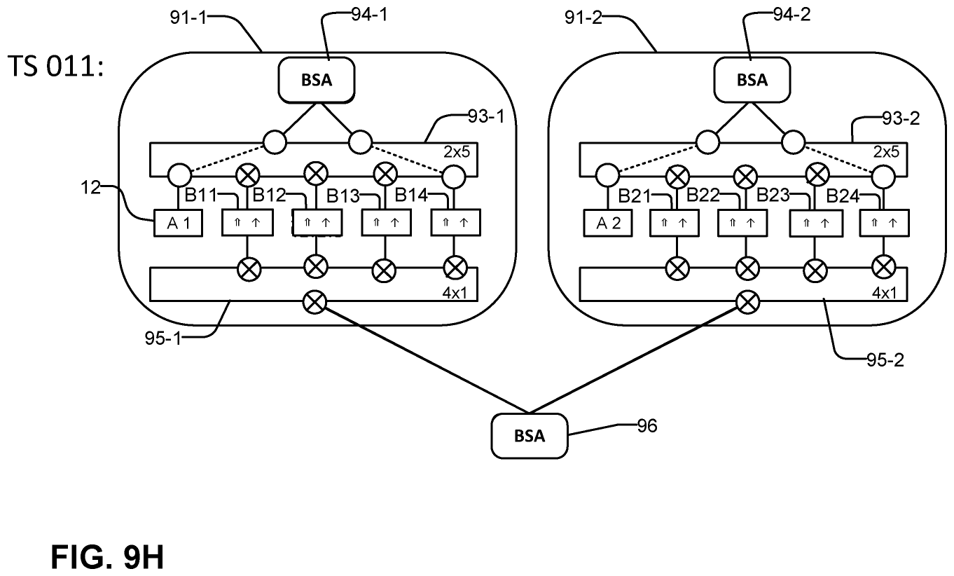

The following illustrative example demonstrates some features of methods and apparatus according to some embodiments of the invention using the network 90 illustrated in FIG. 9A which includes quantum systems that are arranged in two nodes 91-1 and 91-2 (generally and collectively nodes 91). Additional nodes 91 (not shown in FIG. 9A are optionally present. Network 90 includes an inter-node entanglement mechanism 99 that is operable to create entanglement among quantum systems in different ones of nodes 91. In network 90 the inter-node entanglement mechanism 99 includes inter-node BSA 96, associated optical links 98 and optical switches 95 (switches 95-1 and 95-2 are shown in FIG. 9A). One or more quantum systems in each node 91 are isolated from (not connected to) inter-node entanglement mechanism 99. These quantum systems may be said to be associated with an alpha level. Each node includes one or more quantum systems that is connected to inter-node entanglement mechanism 99. These quantum systems may be said to be associated with a beta level.

In network 90, each node 91 includes one alpha level set of quantum systems (labelled A1 in node 91-1 and A2 in node 91-2). Each node 91 also includes a number of sets of beta level quantum systems. In this example, each node 91 includes four sets of beta level quantum systems which are labelled B11 to B14 in node 91-1 and B21 to B24 in node 92-2.

In this example, each set of quantum systems includes two quantum systems indicated by ↑ and [symbol] respectively. Quantum systems 1 may, for example, comprise electron spins. Quantum systems [symbol] may, for example, comprise nuclear spins. Within each set, quantum systems ↑ and [symbol] may be coupled (e.g. by hyperfine interaction). For example, each set of quantum systems B11, B22 etc. may comprise an electron spin of a T centre and a nuclear spin of the T centre.

Each node 91 includes a first optical switch 93 (individually identified as 93-1 and 93-2) that is operable to connect any two of the alpha level quantum system (A1, A2) of the node and the beta level quantum systems (B11, B12, etc., B21, B22 etc.) of the node to an intra-node Bell state analyzer 94. Each node 91 includes a second optical switch 95 (individually identified as 95-1 and 95-2) that is operable to connect any of the beta quantum systems 12 of the node to an inter-node Bell state analyzer 96.

An intra-node Bell state analyzer 94 may be applied to either create entanglement of pairs of quantum systems 12 within a node 91 or to make measurements on quantum systems 12 within the node 91. Typically, only one of these functions may be performed at one time. Intra-node Bell state analyzers 94 have an “entanglement mode” for entanglement attempts and a “measurement mode” for making measurements. Inter-node Bell state analyzer 96 may be applied to create entanglement of beta level quantum systems 12 of different nodes 91.

Network 90 additionally includes means for applying quantum gates to quantum systems ↑ and [symbol] (e.g. by applying patterns of optical and/or microwave pulses as is known in the field). For example, a SWAP gate may be applied to swap quantum states of quantum systems ↑ and [symbol] of one of the sets of quantum systems

In some embodiments, entanglement scheduler 22 determines pairs of quantum systems to be entangled to support operation of a quantum circuit and then works to generate the entanglement. Generating entanglement is typically performed over a series of entanglement timesteps during which attempts to entangle selected pairs of quantum systems may be made. In some embodiments, entanglement scheduler 22 maintains a record that includes: which pairs of quantum systems are currently entangled (entanglement inventory), for which pairs of quantum systems should entanglement be attempted in the next available timestep (active entanglement needs), the current status of network 90 (e.g. configurations of optical switches, operational modes of BSAs). Entanglement scheduler 22 may use this record to determine whether and how to change the configuration of network 90 for the next entanglement timestep.

In some embodiments it may not be possible, practical or desirable to directly create entanglement between some quantum systems of a node 91 and other quantum systems. For example, where quantum systems [symbol] are nuclear spins network 90 may not support directly entangling two nuclear spins, In such cases, where entanglement is desired between nuclear spins of two sets of quantum systems (e.g. two T centres), entanglement scheduler 22 may be configured to coordinate creation of entanglement between the spins ↑ or the respective sets (e.g. electron spins) and to subsequently swap the resulting entanglement to the nuclear spins.

After the entanglement attempts at each timestep have been completed, entanglement scheduler 22 may update the entanglement inventory and active entanglement needs to reflect any successful entanglement attempts in the current timestep. Entanglement scheduler 22 may determine whether there is room to add any additional entanglement attempts to the active entanglement needs for the next timestep (which additional entanglement attempts can be performed while network 90 is configured to attempt entanglement corresponding to the current active entanglement needs and also will not disrupt valuable already-existing entanglement in the entanglement inventory). Entanglement scheduler 22 may then configure network 90 for the next timestep.

In this example:
up to five entanglement attempts may be made per instruction cycle (i.e. between subsequent execution stages);
the entanglement attempts are performed sequentially, one at a time;
entangling one of the beta quantum systems of one node with one of the beta quantum systems of another node (“inter-node entanglement”) takes, on average, three entanglement attempts; and
entangling any two quantum systems 12 within one node 91 (“intra-node entanglement”) takes, on average, two entanglement attempts.

Suppose that it is desired to execute processing according to the quantum circuit 100 shown in FIG. 10. An entanglement scheduler 22 may schedule entanglement attempts to generate the entanglement required by circuit 100. The status of network 90 at timesteps 000 through 012 in an example run is shown in FIGS. 9A to 9I.

Scheduler 22 may use various approaches for determining when to commence entanglement attempts so that required entanglement will be available when needed. For example, in some embodiments, scheduler 22 is provided with and/or determines specific time steps by which certain entanglement is required. Schedule 22 may work backward from these time steps to determine when to commence attempts to provide the required entanglement. In some embodiments, scheduler 22 is responsible for processing a quantum informatics program and assigning entanglement to time steps.

In some embodiments, entanglement scheduler 22 takes into account dependencies of different required entanglements (e.g. a certain entanglement will be needed only after completion of some step (a “gating step”) in the quantum informatics program—entanglement scheduler 22 may base a decision on when to commence attempts to provide the certain entanglement on the progress toward completion of the gating step).

Entanglement scheduler 22 may consider loss profiles in determining how to achieve entanglement of a pair of quantum systems. A loss profile indicates the reliability (probability of success) of entanglement attempts between pairs of quantum systems. Different loss profiles may be specified for different network configurations. Entanglement scheduler 22 may be configured to select network configurations (e.g. settings of optical switches, selections of BSAs to use for entanglement attempts etc.) so that the probability of success of the entanglement attempts is maximized (e.g. by selecting network configurations which provide lower loss paths for use in entanglement attempts).

In some embodiments, entanglement scheduler 22 performs an optimization which attempts to select an order or entanglement attempts and/or network configurations for the entanglement attempts which minimizes the expected time for creating desired entanglement. The optimization may take into consideration the fact that a network configuration that is best (e.g. lowest loss) for creating entanglement of one pair of quantum systems may be sub-optimum for creating entanglement of other pairs of quantum systems. Entanglement scheduler 22 may optimize network configurations for efficiently generating plural entanglements by minimizing the expected total number of entanglement attempts and/or minimizing the expected time (e.g. number of steps) required to generate the plural entanglements.

For example, entanglement scheduler 22 may access information that indicates an average number of entanglement attempts required to successfully form an entangled pair. In some embodiments this information comprises statistics regarding the efficiency of entanglement attempts for different pairs of quantum systems. For example, efficiency of entanglement attempts may be specified for individual pairs of quantum systems and/or for individual pairs of quantum systems for different hardware configurations. For example, when entanglement scheduler 22 has several pairs of quantum systems to entangle to create an entanglement swapping chain, entanglement scheduler 22 may schedule attempts to entangle those of the pairs of quantum systems for which each entanglement attempt has a lower probability of success to be performed before attempts to entangle those of the pairs of quantum systems for which each entanglement attempt has a higher probability of success. For example, if inter-node entanglement is less efficient (higher loss) than intra-node entanglement entanglement scheduler may prioritize attempts to create required inter-node entanglement over attempts to create required intra-node entanglement in cases where these attempts cannot be performed simultaneously.

In some embodiments entanglement scheduler 22 maintains a data structure that contains information regarding dependencies of required entanglements (e.g. one entangled pair may be needed only after another entangled pair has been created or only if execution of a quantum informatics program takes a certain branch). The data structure may, for example, be a tree structure. Entanglement scheduler 22 may commence attempts to generate required entanglement based on progress toward completion of dependencies. For example, where a second entangled pair is required after a first entangled pair has been created then entanglement scheduler 22 may schedule attempts to create the second entangled pair to start after entanglement of the first entangled pair has been at a achieved or else at a time when a certain level or progress toward creating the first entangled pair has been achieved (e.g. when a certain proportion of segments of an entanglement swapping chain for generating the first entangled pair are complete). In some embodiments, scheduler 22 may be configured to schedule entanglement of the first and second entangled pairs to overlap or be performed concurrently. As another example, where a certain entangled pair is required only if a quantum informatics program takes a specific branch or path then entanglement scheduler 22 may commence attempts to generate the entangled pair when the likelihood that the quantum informatics program will take the branch or path reaches a threshold probability. In some embodiments, where a quantum informatics program has plural branches that have different entanglement requirements then entanglement scheduler 22 may be configured to attempt to create entanglement to support two or more or all of the plural branches. In some embodiments, entanglement scheduler 22 uses any of the above approaches and/or any combination of one or more of these and other approaches.

### Timestep 000 (FIG. 9A):

At timestep 000 (FIG. 9A) entanglement scheduler 22 establishes an entanglement plan. Entanglement scheduler 22 may begin by processing circuit 100. Entanglement scheduler 22 determines that:
network 90 has the topology shown in FIG. 9A;
there are no entangled states in inventory;
switch 93-1 is configured to directly couple quantum systems B13 and A1 to respective inputs of intra-node BSA 94-1;
switch 93-2 is configured to couple quantum systems B23 and A2 to respective inputs of intra-node BSA 94-2;
switches 95-1 and 95-2 are respectively configured to directly couple quantum systems B14 and B24 to respective inputs of inter-node BSA 96.

After performing the status check, entanglement scheduler 22 may look ahead in circuit 100 to identify required entanglement. In this example, entanglement scheduler 22 determines that circuit 100 includes two instruction cycles. Scheduler 22 determines that circuit 100 requires creation of two entangled pairs of quantum systems (“Bell pairs”), one after the other. Once the first Bell pair is created, measurements M are made on the Bell pair.

In this example, entanglement scheduler 22 schedules a first Bell pair to be complete at execution stage 010 and a second Bell pair to be complete at execution stage 020. Each of these Bell pairs requires entanglement between quantum systems A1 of node 91-1 and A2 of node 91-2.

In this example, entanglement scheduler 22 determines that a chain of entanglement may be used to create the requested entanglement of quantum systems A1 and A2. In this example the chain is made up of the segments A1-B1n(↑) (where n is 1, 2, 3 or 4), B1n( [symbol] )-B2m( [symbol] ) (where m is selected from 1, 2, 3 or 4) and B2m(↑)-A2. Another example entanglement chain is made up of the segments A1-B1n (where n is 1, 2, 3 or 4), B1m1-B2m2 (where m1 and m2 are each selected from 1, 2, 3 or 4 and m1≠n) and B2p-A2 (where p is selected from 1, 2, 3 or 4 and m2≠p).

Entanglement swapping to entangle A1 and A2 may, for example, be done by performing BSMs between quantum systems B1n(↑) and B1n( [symbol] ), and B2m(↑) and B2m( [symbol] ) respectively. Once entanglement has been created between quantum systems A1 and A2 (e.g. A1(↑) and A2(↑) or A1( [symbol] ) and A2( [symbol] )), intra-node BSAs 94-1 and 94-2 may be used as measuring instruments to perform measurements on quantum systems A1 and/or A2 respectively as required by circuit 100. These measurement(s) s may be deterministic. These measurements may be performed as part of execution stage 10. The measurement(s) will consume the entanglement of quantum systems A1 and A2 so that this entanglement will need to be re-created to provide the renewed entanglement of A1 and A2 required for the second instruction cycle 20.

As discussed above, entanglement scheduler 22 may generate a plan to create segments of an entanglement swapping chain which can be used to entangle quantum systems A1 and A2. Entanglement scheduler 22 may, for example, select the case of n=3 and m=3 so that the entanglement swapping chain will be made up of the segments A1-B13(↑), B13( [symbol] )-B23( [symbol] ) and B23(↑)-A2. Since no quantum systems should be simultaneously connected to inter-node BSA 96 and intra-node BSA 94, the same configuration of the switches of nodes 91-1 and 91-2 cannot be used to create all segments of the entanglement swapping chain which will be used to create entanglement of quantum systems A1 and A2 for execution stage 10. Any excess capacity for performing entanglement attempts may be used to generate the entanglement required by circuit 100 for execution stage 20 and/or to generate entanglement that may be maintained in inventory in case it is useful later.

In preparation for entanglement attempts, entanglement scheduler 22 sends instructions to configure switches as shown in FIG. 9B to connect BSAs for creating entanglement between quantum systems:
B13( [symbol] )-B23( [symbol] ) (segment of the entanglement swapping chain for creating the first entanglement of A1, A2—this segment is scheduled first because the probability of an entanglement attempt being successful is lower than for the other segments of the entanglement swapping chain this entanglement may be generated by entangling B13(↑)-B23(↑) and then applying SWAP gates to each of B13 and B23 to cause the entanglement of B13( [symbol] )-B23( [symbol] ))
B11(↑)-B12(↑); (for inventory)
B21(↑)-B22(↑); (for inventory)

These entanglements are then attempted at timestep 001.

### Timestep 001 (FIG. 9B):

The above entanglement attempts proceed at timestep 001. If any of the entanglement attempts succeed, they are added to the inventory of entangled quantum systems. In response to successful entanglements, switches may be reconfigured to facilitate entanglement attempts for other pairs of quantum systems. Otherwise, the switch configuration may be kept the same to allow the entanglement attempts to be repeated. In this example, no entanglement attempts succeeded at timestep 001. As a result, in this example the configuration of switches 93-1, 95-1, 93-2 and 95-2 are maintained for timestep 002.

### Timestep 002 (FIG. 9C):

In timestep 002 the failed entanglement attempts of timestep 001 are repeated. In this example, entanglement of quantum systems B13( [symbol] )-B23( [symbol] ) and B11(↑)-B12(↑) succeeded at timestep 002 but the attempted entanglement of B21(↑)-B22(↑) failed. Entanglement scheduler 22 therefore records:

| | |
|---|---|
| Entanglement Inventory: | B13( [symbol] )-B23( [symbol] ) and B11(↑)-B12(↑) |
| Active entanglement needs: | B13( [symbol] )-B23( [symbol] ) |
| Intra-Node BSA 94-1 status: | Entanglement mode |
| Intra-Node BSA 94-2 status: | Entanglement mode |
| Quantum systems to measure: | None |
| Quantum systems inactive due to | None |
| use by circuit: | |

Based on the recorded information, entanglement scheduler 22 sends instructions to change the switch configuration before the start of the next entanglement time step 003 such that entanglement attempts may be made to provide the remaining segments A1-B13(↑) and A2-B23(↑) of the entanglement chain for creating entanglement of A1-A2 for execution stage 010. The switch configuration may also accommodate one or more new entanglement attempts to create entangled pairs of quantum systems to satisfy future requirements of circuit 100. In this example, the switches are set as shown in FIG. 9D to facilitate entanglement attempts:
A1-B13(↑)
A2-B23(↑) and
B14( [symbol] )-B24( [symbol] ) (which is a segment of an entanglement chain that may be used to create entanglement A1-A2 for execution stage 020).

The status of entanglement attempts and entangled quantum systems managed by entanglement scheduler 22 is:

| | |
|---|---|
| Entanglement Inventory | B13( [symbol] )-B23( [symbol] ) and B11(↑)-B12(↑) |
| Active Entanglement Needs: | A1-B13(↑), A2-B23(↑) and |
| | B14( [symbol] )-B24( [symbol] ) |
| Intra-Node BSA 94-1 status: | Entanglement mode |
| Intra-Node BSA 94-2 status: | Entanglement mode |
| Quantum systems to measure: | None |
| Quantum systems inactive due to | None |
| use by circuit: | |

### Timestep 003 (FIG. 9D):

In this example the entanglement attempts A1-B13(↑) and B14( [symbol] )-B24( [symbol] ) succeeds at timestep 003 and entanglement of A2-B23(↑) fails, at timestep 003. Entanglement scheduler will record:

| | |
|---|---|
| Entanglement Inventory | A1-B13(↑), B13( [symbol] )-B23( [symbol] ), |
| (unchanged): | B14( [symbol] )-B24( [symbol] ) |
| | and B11(↑)-B12(↑) |
| Active entanglement needs: | A2-B23(↑), |
| Intra-Node BSA 94-1 status: | Entanglement mode |
| Intra-Node BSA 94-2 status: | Entanglement mode |
| Quantum systems to measure: | None |
| Quantum systems inactive due to | None |
| use by circuit: | |

Based on the record, entanglement scheduler 22 maintains the current configuration of switch 93-2 for timestep 004 so that the active entanglement attempt A2-B23(↑) can be repeated.

### Timestep 004 (FIG. 9E):

In this example, Entanglement Scheduler 22 records:

| | |
|---|---|
| Entanglement Inventory: | A1-B13(↑); B13( [symbol] )-B23( [symbol] ); |
| | B14( [symbol] )-B24( [symbol] ); |
| | and B11(↑)-B12(↑) |
| Active entanglement needs: | A2-B23(↑) |

At timestep 004, entanglement scheduler 22 repeats the entanglement attempt A2-B23(↑). This attempt succeeds. Entanglement scheduler could optionally schedule other entanglement attempts in timestep 004 to add to the entanglement inventory. However, in this example only the entanglement A2-B23(↑) is attempted at timestep 004.

After the entanglement attempt of timestep 004, all segments of an entanglement swapping chain that can be used to entangle A1-A2 have been generated. Entanglement scheduler 22 therefore configures network 90 to perform an entanglement consumption step in timestep 005 which involves performing BSMs on B13 and B23, thereby consuming the entanglement of the entanglement chain to generate the entanglement A1-A2 as required for execution step 010. These BSMs are made using BSAs 94-1 and 94-2 in measurement mode. (as indicated by “(M)” in FIG. 9F). Consequently entanglement scheduler 22 cannot schedule any intra-node entanglement attempts until after the entanglement swapping is completed.

### Time Step 005 (FIG. 9F):

In this example, entanglement swaps are performed with the result that A1-A2 are entangled.

### Time Step 010 (FIG. 9G):

In this example, at timestep 010 the entanglement of A1-A2 that was generated at timestep 005 is consumed in the operations to perform circuit 100. For example, BSAs 94-1 and/or 94-2 still in measurement mode may be respectively used to make measurements of A1 and/or A2 as required by circuit 100.

FIG. 9G illustrates that network 90 may optionally be configured to attempt entanglement of B13( [symbol] )-B23( [symbol] ) during timestep 010. If the entanglement attempt is successful (as it is in this example) I, the entanglement B13( [symbol] )-B23( [symbol] ) may be added to inventory for possible future use.

At the end of timestep 010, entanglement scheduler 22 records:

| | |
|---|---|
| Entanglement Inventory: | B14( [symbol] )-B24( [symbol] ); B13( [symbol] )-B23( [symbol] ) |
| | and B11(↑)-B12(↑) |
| Active entanglement needs: | A1-B14(↑), A2-B24(↑), |

Entanglement scheduler 22 returns intra-node BSAs 94-1 and 94-2 to entanglement mode and configures switches of network 90 in preparation for entanglement timestep 011. Entanglement timestep 011 will attempt entanglement of A1-B14(↑) and A2-B24(↑) which may be used to provide entanglement of A1-A2 for execution stage 020.

### Timestep 011 (FIG. 9H):

In this example, no entanglement attempts succeed at timestep 011.

Entanglement Scheduler records:

| | |
|---|---|
| Entanglement Inventory: | B11(↑)-B12(↑); B13( [symbol] )-B23( [symbol] ); |
| | B14( [symbol] )-B24( [symbol] ) |
| Active entanglement needs: | A1-B14(↑); A2-B24(↑) |

Entanglement scheduler 22 keeps the current settings of switches to repeat the attempts to create entanglement of segments of an entanglement swapping chain that may be used to generate entanglement of A1-A2 for execution stage 020.

### Timestep 012 (FIG. 9I):

For this example, the entanglement attempts A1-B14(↑) and A2-B24(↑) each succeed at timestep 012. Therefore, a complete entanglement swapping chain between A1-A2 has been created. Entanglement of A1-A2 may be generated by performing BSMs on B14 and B24 (e.g. using BSAs 94-1 and 94-2 in measurement mode). These measurements may be made as early as at timestep 013, which is three timesteps before timestep 020 in which the entanglement of A1-A2 is scheduled to be utilized by circuit 100. In response to determining that the entanglement required by execution stage 020 is available, entanglement scheduler 22 may be configured to perform one or more of the following actions:
speed up the run-time of circuit 100 by skipping timesteps 014-015 to go straight to execution stage 020;
use some of the entanglement that is in inventory for some purpose other than creating the entanglement required by execution stage 020 and to replace the entanglement required for execution stage 020;
use timesteps 014 and/or 015 to create additional entanglement for later use.

In some embodiments, entanglement scheduler 22 is configured to select between using created entanglement for its originally intended purpose or for some other purpose. For example, in a more complex circuit entanglement from an entanglement inventory may be used to compensate for a previously failed gate, and/or to move quantum states among the physical quantum systems of network 90 by quantum teleportation instead of holding the entanglement until needed by the circuit.

This example demonstrates that an entanglement scheduler 22 can work together with quantum systems of a network to efficiently execute a quantum circuit. The network may have a layered architecture. By being able to in parallel use lower-loss connections (e.g. intra-node beta level to beta level connections) while establishing the first set of entangled states, the second set of entangled states only took 2 timesteps (011 and 012) to complete an entanglement chain for entangling A1-A2 instead of five timesteps to complete even though quantum systems A1 and A2 needed to be reset after the execution stage at timestep 010.

### Examples of Included Variations

The present technology is not limited to application to quantum systems of any particular type although it is currently considered that quantum systems such as T centers in a crystalline substrate have significant advantages in comparison to other types of quantum systems that may be used to store and manipulate quantum information. Nodes of networks as described herein may include other types of quantum systems such as: spin-photon interfaces that interact with other neighboring spins; ion traps with one or more ions in the same trap; ensembles of superconducting qubits combined with a transducer that performs transduction of microwave photon states from at least one of the superconducting qubits to optical photons.

In some embodiments some quantum systems may be replaced by photon sources that are configured to emit photons having selected quantum states. The photon sources may emit photons as a result of optical transitions (e.g. spin selective optical transitions). For example, the photon sources may comprise particles that have intrinsic spins such as electrons or nuclear spins. However, photon sources may have other constructions. For example, a photon source may comprise a light source, such as a laser, an attenuator set to attenuate the laser light to the single photon level, and one or more modulators configurable to modulate single photons to have desired photon states (e.g. polarization states, time bin states, or the like). Photons from any of these photon sources may be allowed to interact with quantum systems in a network as described herein and/or with photons emitted by such quantum systems in the course of quantum informatics processes. The photon states may, for example represent data being input into a quantum informatics process such as sensor readings, values of input parameters or the like.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

The invention may also be embodied in the form of a program product. The program product may comprise any non-transitory medium which carries a set of computer-readable instructions which, when executed by a data processor, cause the data processor to execute a method of entanglement management and/or entanglement scheduling as described herein. In some embodiments an entanglement scheduler 22 comprises such a program product in combination with a data processor. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A control system for a network of quantum systems, the control system operable to operate the network of quantum systems to perform quantum informatics processing, the control system comprising an entanglement scheduler, the entanglement scheduler configured to:
for a plurality of operations to be performed on the quantum systems of the network:
identify one or more of the operations that require entanglement of quantum states of two or more of the quantum systems;
identify plural potential entanglement attempts for generating the required entanglement based at least on a characterization of the required entanglement; and
schedule at least some of the potential entanglement attempts to be performed to generate the required entanglement for at least one of the operations prior to execution of the at least one of the operations.

2-3. (canceled)

4. The control system according to claim 1 wherein the characterization of the required entanglement comprises a fidelity for the required entanglement.

5. The control system according to claim 1 wherein the characterization of the required entanglement comprises a level of criticality of the operation associated with the entanglement.

6. The control system according to claim 1 wherein scheduling at least some of the potential entanglement attempts comprises identifying a hardware conflict that blocks simultaneous execution of two or more of the potential entanglement attempts and scheduling the two or more of the potential entanglement attempts to be performed at different times in response to the identification of the hardware conflict.

7. The control system according to claim 1 wherein the network comprises a plurality of optical switches and the control system is configured to control states of the optical switches to configure the network for executing the at least some of the scheduled potential entanglement attempts.

8-18. (canceled)

19. The control system according to claim 1 wherein the entanglement scheduler is configured to assign a weight to each of the potential entanglement attempts and scheduling the potential entanglement attempts in an order that is based on the corresponding weights.

20. The control system according to claim 19 wherein the weight is assigned based at least in part on one or more of the following factors:
an estimated length of time before execution of one of the operations associated with the entanglement attempt;
a number of other operations to be executed before execution of one of the operations associated with the entanglement attempt;
a probability of success of the entanglement attempt;
an expected fidelity of entanglement that will be generated if the entanglement attempt succeeds;
a time required to configure hardware components of the network to perform the entanglement attempt;
a time required to perform the entanglement attempt;
a measure of how much a configuration of the hardware components of the network to perform the entanglement attempt conflicts with performing other ones of the potential entanglement attempts;
a criticality of one of the operations associated with the potential entanglement attempt; and
a priority of an entanglement chain associated with the potential entanglement attempt.

21. The control system according to claim 1 wherein the control system is configured to execute the operations in a sequence of execution stages and to perform selected ones of the potential entanglement attempts in plural entanglement generation stages in periods between successive ones of the execution stages.

22-23. (canceled)

24. The control system according to claim 21 wherein the entanglement scheduler is configured to, after each of the entanglement generation stages, determine results of the entanglement attempts performed in the entanglement generation stage and, based on the determined results update the schedule of potential entanglement attempts.

25-27. (canceled)

28. The control system according to claim 1 wherein the entanglement scheduler is configured to, in response to determining that the required entanglement corresponding to one of the one or more operations has not been achieved by a scheduled time of execution of the one of the one or more operations, perform one or more of:
modify the program by scheduling one or more remedial operations; and
delay execution of the one of the one or more operations; and
pause execution of operations of the program until the required entanglement corresponding to the one of the one or more operations has been achieved.

29. The control system according to claim 1 wherein the entanglement scheduler is configured to, in response to determining that the required entanglement corresponding to one of the one or more operations has been achieved bring forward scheduled execution of the one or more operations.

30. (canceled)

31. The control system according to claim 1 wherein the control system is configured to maintain an inventory of entangled pairs of the quantum systems of the network and to create potential entanglement requests to add entangled pairs to the inventory when the inventory is below a desired level.

32. The control system according to claim 4 wherein the entanglement scheduler is configured to, in response to determining that the fidelity of the required entanglement exceeds a threshold value, include in the potential entanglement attempts a plurality of potential entanglement attempts between one or more pairs of the quantum systems, execute the plurality of potential entanglement attempts between the one or more pairs of the quantum systems to achieve entanglement of the one or more pairs of the quantum systems and perform entanglement distillation involving the one or more pairs of the quantum systems to yield the required entanglement.

33. The control system according to claim 32 wherein the quantum systems of the network include at least two luminescent centres that each include an electron spin and a nuclear spin wherein the control system is configured to:
a, entangle the electron spins of a pair of the luminescent centres;
b, transfer the entanglement to the nuclear spins of the pair of the luminescent centres;
c, repeat step (a); and
d, perform entanglement distillation between the entangled electron spins and the nuclear spins.

34-41. (canceled)

42. A method for operating a network of quantum systems to perform quantum informatics processing, the method comprising:
processing a program that specifies operations to be performed on the quantum systems of the network to: identify one or more operations that require entanglement of quantum states of two or more of the quantum systems;
based on a characterization of the required entanglement for the one or more operations, identifying plural potential entanglement attempts for generating the required entanglement; and
scheduling one or more of the potential entanglement attempts to be performed to generate the required entanglement for at least one of the operations prior to execution of the at least one of the operations.

43-45. (canceled)

46. The method according to claim 42 comprising assigning a weight to each of the potential entanglement attempts and scheduling the potential entanglement attempts in order of the corresponding weights.

47. The method according to claim 46 wherein the weight is based at least in part on one or more of:
an estimated length of time before scheduled execution of one of the operations associated with the potential entanglement attempt;
a number of other operations to be executed before execution of one of the operations associated with the potential entanglement attempt;
a criticality of one of the operations associated with the potential entanglement attempt; and
a priority of an entanglement chain associated with the potential entanglement attempt.

48. The method according to claim 42 comprising executing the operations in a sequence of execution stages and performing selected ones of the potential entanglement attempts in plural entanglement generation stages in periods between successive ones of the execution stages.

49-51. (canceled)

52. The method according to claim 42 comprising monitoring execution of the potential entanglement attempts and, in response to determining that the required entanglement corresponding to the one or more operations has not been achieved by a scheduled time of execution of the one or more operations, performing one or more of:
modify the program by scheduling one or more remedial operations in lieu of the one or more operations; and
delay execution of the one or more operations; and
pause execution of the program until the required entanglement corresponding to the one or more operations has been achieved.

53. The method according to claim 42 comprising, in response to determining that a fidelity of the required entanglement exceeds a threshold value, including in the potential entanglement attempts a plurality of potential entanglement attempts between a plurality of different pairs of the quantum systems, executing the plurality of potential entanglement attempts between the plurality of different pairs of the quantum systems to achieve entanglement of the plurality of different pairs of the quantum systems and performing entanglement distillation on the plurality of different pairs of the quantum systems to yield the required entanglement.

54-59. (canceled)
